(19) United States
(12) Patent Application Publication
(10) Pub. No.: US 2023/0331961 A1
(43) Pub. Date: Oct. 19, 2023

(54) BIODEGRADABLE COMPOSITE MATERIAL OF PURE AMYLOSE AND CELLULOSE NANOFIBRES OR CELLULOSE NANOCRYSTALS

(71) Applicant: University of Copenhagen, Copenhagen K (DK)

(72) Inventors: Bodil Jørgensen, Copenhagen K (DK); Peter Ulvskov, Copenhagen K (DK); Andreas Blennow, Copenhagen K (DK); Marwa Faisal, Copenhagen K (DK)

(21) Appl. No.: 18/043,171

(22) PCT Filed: Sep. 3, 2021
(86) PCT No.: PCT/EP2021/074385

§ 371 Date: Feb. 27, 2023

(30) Foreign Application Priority Data
Sep. 3, 2020 (EP) 20194311.5

(51) Int. Cl. C08L 3/12; C08L 1/04; C08J 3/18; C08J 5/18; C08B 30/04; C08B 15/02

(52) U.S. Cl. CPC C08L 3/12; C08L 1/04; C08J 3/18; C08J 5/18; C08B 30/042; C08B 15/02; C08J 2301/04; C08J 2401/04; C08J 2303/12; C08J 2403/12

(57) ABSTRACT

Disclosed herein are composite materials comprising amylose, cellulose nanofibres or cellulose nanocrystals, and a plasticiser. The amylose is of high purity, specifically containing little or no amylopectin. The cellulose nanofibres or cellulose nanocrystals act to reinforce the disclosed composite materials. Also disclosed are methods of producing such composite materials, and their use.

### TECHNICAL FIELD

The present invention relates to composite materials of amylose and cellulose nanofibres and/or cellulose nanocrystals. It further relates to food packaging materials comprising such composite material.

### BACKGROUND

Increased plastics pollution in the environment has attained notable attention to find alternative eco-friendly biobased solutions. Such materials refer to renewable resources, preferably of plant-based and waste stream origins, that are biodegradable, compostable and non-toxic. However, production of such all-natural bioplastics is challenging and associated problems related to water sensitivity and brittleness of the products, which makes them unsuitable for many uses.

Starch is a polymeric carbohydrate consisting of glucose units joined by alpha-glucosidic bonds. It consists of two types of polymers: mainly linear amylose (AM) and branched amylopectin.

Cellulose is a polymeric carbohydrate consisting of glycose units joined by beta-glucosidic bonds. It is semicrystalline and usually organised as microfibrils.

Cellulose may be extracted from several different plants. Depending on the pre-treatment method, various types of nano-scale cellulose (nanocellulose) can be obtained. Cellulose nanofibres (CNF) are one such example of a nanocellulose. The fibres are 4-60 nm wide and 0.1-4 μm long. Protocols for preparing CNF from vegetable pulp typically consists of alkaline treatment to strip off non-cellulosic polysaccharides, followed by oxidation of phenolic compounds and finally high-shear homogenization. Another example of a cellulose nanomaterial is cellulose nanocrystals (CNC).

Studies on the reinforcement of starch from cassava with CNF plasticized with a mixture of sorbitol and glycerol (Teixeira et al., Carbohydrate Polymers, 2009, 78(3), 422), showed that the elastic modulus increased with 5 wt. % of CNF. However, at higher content of CNF in the starch (10% and 20%), significant reduction in elasticity occurred, which can be a disadvantage for many applications.

### SUMMARY

Herein is disclosed the preparation and characterization of nanocomposites and films thereof based on pure AM, CNF or CNC, and a plasticiser. The present inventors have surprisingly found that pure AM blended with CNF or CNC and plasticiser provides for a composite material for production of durable and flexible bioplastics. Such AM-CNF casted composite films provide for high mechanical stress at break, high Young's modulus, decreased water contact angles and decreased water vapour and oxygen permeability, particularly at high CNF content. Compared to composite materials prepared from high-amylose starches and cellulose nanofibres, the present AM composites exhibits surprisingly improved mechanical and physical properties which are only achieved at high purity of the amylose. Accordingly, the improved properties could not have been predicted by extrapolation from results relating to high-amylose composites. Specifically, the change in gelatinisation temperature of the disclosed composite materials compared to high-amylose starch-based composites could not have been predicted based on the prior art.

One aspect of the present disclosure provides for a composite material prepared from an amylose composition, a cellulose nanofibre or cellulose nanocrystals, and a plasticiser, wherein said amylose composition comprises at least 96% amylose of the total amount of amylose and amylopectin in said amylose composition, and wherein the composite material comprises in the range of 5 to 60% cellulose nanofibres or 5 to 60% cellulose nanocrystals.

Another aspect of the present disclosure provides for a method of preparing a composite material, said method comprising:
a. providing an amylose composition, wherein less than 1.4% of the glucosidic bonds within the amylose composition are α(1→6) glucosidic bonds, wherein the glucosidic bonds are either α(1→4) or α(1→6) glucosidic bonds;
b. providing cellulose nanofibres or cellulose nanocrystals;
c. providing a plasticiser;
d. mixing said amylose composition, said cellulose nanofibre or cellulose nanocrystals, and said plasticiser in a ratio so that the cellulose nanofibres or the cellulose nanocrystals constitute in the range of 5 to 60% of the weight of the composite material, and
e. heating said mixture to obtain said composite material.

Another aspect of the disclosure provides for a method of preparing a composite material, said method comprising:
a. providing an amylose composition, wherein said amylose composition comprises at least 96% amylose of the total amount of amylose and amylopectin in said amylose composition;
b. providing cellulose nanofibres or cellulose nanocrystals;
c. providing a plasticiser;
d. mixing said amylose composition, said cellulose nanofibre or cellulose nanocrystals, and said plasticiser in a ratio so that the cellulose nanofibres or the cellulose nanocrystals constitute in the range of 5 to 60% of the weight of the composite material, and
e. heating said mixture to obtain said composite material.

A final aspect of the present disclosure provides for a packaging comprising the composite material as disclosed herein.

### DESCRIPTION OF DRAWINGS

FIG. 1: FE-SEM images of AM/CNF pure and composite films, the scale bar represents 3 μm.

FIG. 2: CLSM images of AM/CNF pure and composite films. Top four images: Green flourescence of CNF with PFS 4BS; the dark areas of composites identify AM. Bottom four images: Red staining of AM with safranin O; the dark areas of composites identify CNF domains. Scale bars: 50 μm.

FIGS. 3A-B: FTIR spectra of AM/CNF pure and composite films in the region 4000 -650 cm⁻¹.

FIG. 4: WAXS diffractograms of AM/CNF pure and composite films without glycerol.

FIGS. 5A-C: Mechanical properties of AM/CNF pure and composite films: strain at break, stress at break, and Young's modulus.

FIG. 6: Glass transition (Tg) temperatures of pure and composite films as deduced from DMA.

FIGS. 7: ¹H Spin-lattice relaxation times as a function of CNF and glycerol contents.

FIGS. 8A-D: ¹H solid-state NMR MAS Hahn-echo spectra. FIG. 8A: 0/0/100 (dotted line), 0/50/50 (solid line) and 0/100/0 (dashed line); FIG. 8B: 0/0/100 (dotted line), 15/0/100 (solid line) and 25/0/100 (dashed line); FIG. 8C: 0/50/50 (dotted line), 15/50/50 (solid line) and 25/50/50 (dashed line); FIG. 8D: 0/100/0 (dotted line), 15/100/0 (solid 10 line) and 25/100/0 (dashed line).

FIG. 9: ¹H-¹H NOESY exchange for the 25/100/0 sample.

FIG. 10: Gelatinization profile of 10% AM suspensions recorded in an air-tight high pressure cell. A: the main gelatinization transitions. B Gelation phase.

FIG. 11: Mechanical tensile analysis of films. AOS: amylose only from barley (99% amylose (AM)), HAS: high amylose (50%) starch from maize.

FIG. 12: Mechanical properties of a composite film of amylose only (99%) from barley (AM) and CNF at a ratio of 50:50 (AM 50/CNF50), and a control composite film of high amylose (50%) starch from maize (HA) and CNF at a ratio of 50:50 (HA50/CNF50). A) shows the tensile strength in MPa, B) shows Young's modulus in GPa and C) show strain at break (%).

### DETAILED DESCRIPTION

### Definitions

The term “amylose” as used herein refers to a polysaccharide consisting of α-D-glucose units bonded essentially only via α(1→4) glucosidic bonds. Thus in general in amylose the amount of α(1→4) glucosidic bonds is at least 99,5% of the total amount of α(1→4) glucosidic bonds and α(1→6) glucosidic bonds.

The term “amylopectin” as used herein refers to a polysaccharide of α-D-glucose units consisting of both linear segments of said glucose units linked by α(1→4) glucosidic bonds as well as branching which occurs due to the presence of α(1→6) glucosidic bonds.

As used herein, the “X % amylose” refers to the content of amylose compared to the total amylose and amylopectin content (dry weight) unless otherwise stated. The amylose composition may comprise other compounds, such as impurities or solvent, such as water. However, the X % amylose does not take impurities or water into account. By way of example, an amylose composition consisting of 9 g amylose, 1 g amylopectin, and 1 g water corresponds to a 90% amylose; an amylose composition consisting of 9 g amylose, 1 g amylopectin and 3 g water likewise corresponds to a 90% amylose.

The term “biodegradable,” as used herein, means capable of being biologically decomposed. A biodegradable material differs from a non-biodegradable material in that a biodegradable material can be biologically decomposed into units, which may be either removed from the biological system and/or chemically incorporated into the biological system. One method for determining biodegradability is incubation of the composite material with a mixture comprising microorganisms capable of degrading cellulose and/or starch based polymers for a predetermined period of time, and determining whether said composite material is degraded. Said mixture may for example be sewage sludge and/or compost matrix.

The term “starch” as used herein refers to a polymeric carbohydrate consisting of numerous glucose units joined by α(1→4) glucosidic and α(1→6) glucosidic bonds. Starch is produced in most green plants. Chemically starch consists of two types of molecules, amylose and amylopectin.

The term “cellulose nanofibres” (abbreviated “CNF”) as used herein refers to cellulose fibres having lengths of at least 400 nm, such as of at least 600 nm. Preferably, the CNFs have lengths falling within the range of 400 to 4500 nm, specifically at least 90% of the CNFs have lengths falling within the range of 400 to 4500 nm. Preferably, the CNFs have lengths falling within the range of 600 to 4500 nm, specifically, at least 90% of the CNFs have lengths falling within the range of 600 to 4500 nm. Cellulose nanofibres are typically prepared using methods that aim at preserving as many as possible of the less ordered domains in the cellulose microfibril. In general, cellulose fibres may be purified from natural sources rich in cellulose, such as pulp. Said cellulose fibres may be treated by suitable means to reduce the size of the fibres to above-mentioned size.

The term “cellulose nanocrystals” (abbreviated “CNC”) as used herein refers to cellulose crystals having length of in the range 200-400 nm. They are prepared by strong acid hydrolysis of less ordered domains of the cellulose microfibril.

The term “X comprises in the range of n to m of Y” as used herein refers to that X contains at least n and at the most m of Y. I.e. the term indicates that X does not contain more than m of Y. By way of example, if a composite material is stated to comprise in the range of 5 to 60% cellulose nanofibres, then said composite material does not contain more than 60% cellulose nanofibres.

The term “glucosidic bond” as used herein refers to a covalent bond that joins one glucose unit to another glucose unit. The most common glucosidic bonds are α(1→4) glucosidic bonds and α(1→6) glucosidic bonds. Thus, if nothing else is specified, the term “glucosidic bonds” as used herein refers to α(1→4) glucosidic bonds and α(1→6) glucosidic bonds. α(1→4) glucosidic bonds covalently links the carbon 1 of one alpha-glucose unit to the carbon 4 of another alpha-glucose unit, whereas α(1→6) glucosidic bonds covalently links the carbon 1 of one alpha-glucose unit to the carbon 6 of another alpha-glucose unit. If nothing else is specified, the IUPAC nomenclature for carbohydrates is used. The ratio of α(1→4) glucosidic bonds and α(1→6) glucosidic bonds may be determined by assessed in various ways, but is preferably determined by nuclear magnetic resonance spectroscopy.

The term “modified to reduce expression of a gene” as used herein refers to modification of plant to reduce expression of said gene compared to an unmodified plant. Reduction in expression may either be reduced levels of mRNA and/or reduced levels of protein encoded by said gene. The modification may be a modification introduced by recombinant techniques, such as any of the recombinant techniques described below.

As used herein, the term “plasticiser” refers to a compound that is effective to plasticise the composite material. The term may thus be understood to mean a compound, which, when mixed with an amylose composition under high temperature, lowers the glass transition temperature thereof. The term may also be understood to mean a compound, which, when mixed with an amylose composition under high temperature, lowers the crystallinity thereof. Said high temperature may e.g. be a temperature in the range of 120 to 150° C., and the preparation of such mixture may be carried out in a closed container. Additionally, a plasticiser may decrease brittleness and result in enhanced flexibility upon being incorporated in a composite material of the invention.

Plasticisers are typically low molecular weight, relatively non-volatile molecules that dissolve in a polymer, separating the chains from each other and hence facilitating reptation and reducing the glass transition temperature of the polymer. However, the plasticiser may also be high-molecular weight polymers. In some embodiments, the plasticizer is miscible primarily with amylose and/or the cellulose nanofibres or cellulose nanocrystals. Plasticisers include for example: adipic acid derivatives, such as tridecyl adipate; benzoic acid derivatives, such as isodecyl benzoate; citric acid derivatives, such as tributyl citrate; glycerol itself and derivatives; phosphoric acid derivatives, such as tributyl phosphate; polyesters; sebacic acid derivatives, such as dimethyl sebacate; urea.

As used herein “an interfering RNA” or “iRNA” refers to any double stranded or single stranded RNA sequence, capable—either directly or indirectly (i.e., upon conversion)—of inhibiting or down regulating gene expression by mediating RNA interference. Interfering RNA includes but is not limited to small interfering RNA (“siRNA”) and small hairpin RNA (“shRNA”). “RNA interference” refers to the selective degradation of a sequence-compatible messenger RNA transcript.

As used herein, strain at break (or synonymously elongation at break (EB)) is defined as extension per unit length at break. Strain at break is assessed as outlined in Example 9. The formula for calculating EB is EB=100·ΔL/L₀ where EB is the elongation at break, ΔL is the extension of the films, and L₀ is the initial length of the films. Maximum stress and strain at break (ϵb) were obtained from the stress-strain curves of Example 9.

As used herein: Stress at break also known as tensile strength (TS): measures the maximum stress a plastic specimen (e.g. a composite material) can withstand while being stretched before breaking. Some materials can break sharply while some others will deform or elongate before breaking. Stress is defined as the force per unit area of plastic and has units Nm⁻² or Pa. The formula to calculate tensile stress is TS=Fₘₐₓ/A where TS is the tensile strength, Fₘₐₓ is the maximum load, and A is the initial cross-sectional area of the film sample. Maximum stress (sₘ) and strain at break (ϵb) can be obtained from stress-strain curves. The disclosed stress-distance curves were transformed into stress-strain curves as outlined in ISO 527-2(2012) (Determination of tensile properties of plastics. Retrieved from www.iso.org/obp/ui/#iso:std:56046:en) and ASTM D882(2018) (Standard Test Method for Tensile Properties of Thin Plastic Sheeting. 2018) procedure. Thus, “stress at break” as used herein is preferably determined according to (ISO 527-2(2012) and ASTM D882(2018).

The term “Young's modulus” as used herein is a mechanical property of the composite material, which measures the stiffness. It defines the relationship between stress (force per unit area) and strain (proportional deformation) in the composite material in the linear elasticity regime of a uniaxial deformation. Preferably, the Young's modulus is determined using Instron machine model 5569 (MTS, USA) equipped with a 5 kN tensile load cell, having a distance between clamps of 60 mm and a crosshead speed of 10 mm min₋₁, at 18° C. and 50% humidity.

The term “water contact angle” is defined as the angle formed by the intersection of the tangent lines of a liquid and surfaces of a solid at the three-phase boundary (generally liquid, solid and air) (Wong, Gastineau, Gregorski, Tillin & Pavlath, Journal of Agricultural and Food Chemistry, 1992, 40(4), 540). Preferably, water contact angles are determined at room temperature with a KSV Cam 200 (KSV Instruments Ltd, Helsinki, Finland) using the built-in software (CAM200, KSV instruments).

Composite Material The present disclosure provides for a composite material prepared from an amylose composition, which may be any of the amylose compositions described herein below in the section “Amylose composition”, a cellulose nanofibres described herein below in the section “Cellulose nanofibre” or a cellulose nanocrystals, and a plasticiser, which may be any of the plasticisers described herein below in the section “Plasticiser”.

The material may be produced as described herein below in the section “Producing composite material”. Whereas the composite material may comprise other components in addition to the aforementioned, in some embodiments the composite material may be prepared solely from an amylose composition, a cellulose nanofibre and one or more plasticisers.

Said other components may for example be other polymers or crosslinkers. In a preferred embodiment, said “other components” are biodegradable. It is also preferred that said “other components” are not starch. Thus, the composite material preferably does not comprise any starch, apart from the “amylose composition”. In one embodiment, the composite material of the present disclosure comprises less than 15%, such as less than 10% for example no gelatine.

The composite material of the disclosure comprises both an amylose composition and cellulose nanofibres or cellulose nanocrystals. In a preferred embodiment of the present disclosure, the ratio by weight of amylose composition to cellulose nanofibre or cellulose nanocrystals in the composite material of the disclosure is in the range of 20:1 to 1:10. In a further embodiment, this ratio is in the range of 20:1 to 1:5. In an even further embodiment, this ratio is in the range of 20:1 to 1:3. In yet another embodiment, the ratio by weight of amylose composition to cellulose nanofibre or cellulose nanocrystals in the composite material of the disclosure is in the range of 20:1 to 1:2.

### Amylose Composition

The employed amylose composition has a high degree of purity. Thus, the “amylose composition” to be used with the invention is a composition consisting amylose and optionally a minor fraction of impurities. Said impurities may for example be amylopectin, lipids and protein.

The polysaccharide amylose is consists of α-D-glucose units bonded via α(1→4) glucosidic bonds. This effects a linear polymer, which can more readily crystallise, potentially exhibiting improved chemical, physical, or mechanical properties compared to starch having a low content of amylose. Thus, in one embodiment of the present disclosure, the amylose composition of the disclosure comprises at least 96% amylose compared to the total amount of amylose and amylopectin in said amylose composition, such as at least 97% amylose, such as at least 98% amylose, such as at least 99% amylose compared to the total amount of amylose and amylopectin in said amylose composition. The content of amylose in a composition may be assessed via any suitable analytical method, but is preferably determined using size exclusion chromatography as out lined in Blennow et al. Int J Biol Macromol, 2001, 28, 409. Alternatively, the amount of amylose may also be assessed using the amylose iodine test, as amylose and iodine form a coloured complex.

A typical source of amylose is starch, which is produced in most green plants and which may be feasibly obtained from for instance maize, wheat, potato, tapioca, and rice. However, starch obtained from conventional crops also contain amylopectin. Amylopectin differs from amylose in that it consists of both linear segments of glucose units linked by α(1→4) glucosidic bonds as well as branching which occurs due to α(1→6) glucosidic bonds. The inventors have found that the presence of amylopectin may be a disadvantage for starch based composite materials. Depending on the type of plant, the obtained starch may contain 20 to 25% amylose and 75% to 80% amylopectin. Certain plants produce starch that has an especially high amylose content. This starch is referred to as high-amylose starch. Dunn and Krueger (Macromol Symp, 1999, 140, 179) has reported that amylomaize V and amylomaize VII produce starch that contain 50.8% and 71.7% amylose compared to the total amount of amylose and amylopectin in the starch, respectively. These starches nevertheless still contain a high amount of amylopectin.

One embodiment of the present disclosure provides for a composite material as disclosed herein, comprising an amylose composition comprising less than 4% amylopectin, such as less than 3% amylopectin, such as less than 2% amylopectin, such as less than 1% amylopectin, such as no amylopectin. Another embodiment of the disclosure provides for a composite material, wherein the composite material comprises less than 4% amylopectin, such as less than 3% amylopectin, such as less than 2% amylopectin, such as less than 1% amylopectin, such as no amylopectin. The content of amylopectin in the amylose composition may be assessed via any suitable analytical method, but is preferably determined using size exclusion chromatography.

The purity of an amylose composition can be determined in different ways. In one embodiment the purity of the amylose composition is described as the content of amylose by weight. With respect to amylose content in starch, the ratio of α(1→4) to α(1→6) bonds may also be a useful way of describing the purity of an amylose composition, as is the amount of α(1→6) bonds in relation to the total amount of α(1→4) and α(1→6) glucosidic bonds in the starch. Dunn and Krueger (Macromol Symp, 1999, 140, 179) found that amylose purified from starch (Maize Amylose) consisting of 99% amylose (compared to the total amount of amylose and amylopectin in said starch) contained 0.49% α(1→6) glucosidic bonds and exhibited a α(1→4)/α(1→6) ratio of 203.7. At the other end of spectrum, a starch (from Waxy Maize) containing no amylose contained 5.26% α(1→6) glucosidic bonds and exhibited a α(1→4)/α(1→6) ratio of 19. The relative ratio between α(1→4) bonds and α(1→6) bonds may be assessed using a suitable method, preferably however it is assessed by as nuclear magnetic resonance (NMR) spectroscopy (Dunn and Krueger, Macromol. Symp. 1999, 140, 179). Thus, in one embodiment of the present disclosure, the amylose composition comprises less than 1.4% α(1→6) glucosidic bonds, such as less than 1.2% α(1→6) glucosidic bonds, such as less than 1.0% α(1→6) glucosidic bonds, such as less than 0.8% α(1→6) glucosidic bonds, such as less 0.6% α(1→6) glucosidic bonds, such as 0.5% α(1→6) glucosidic bonds, compared to the total amount of α(1→4) and α(1→6) glucosidic bonds. In a preferred embodiment of the disclosure, the amylose composition comprises less than 0.6% α(1→6) glucosidic bonds, compared to the total amount of α(1→4) and α(1→6) glucosidic bonds. In one embodiment, the amylose composition comprises a ratio of α(1→4) glucosidic bonds to α(1→6) glucosidic bonds of at least 80, such as at least 100, such as at least 120, such as at least 140, such as at least 160, such as at least 180, such as at least 200, such as at least 220, such as at least 240. In a preferred embodiment of the present disclosure, the amylose composition comprises a ratio of α(1→4) glucosidic bonds to α(1→6) glucosidic bonds of at least 240.

The relationship between the ratio of α(1→4) glucosidic bonds to α(1→6) glucosidic bonds and the content of α(1→6) glucosidic bonds compared to the total amount of α(1→6) and α(1→4) glucosidic bonds is given by the following formula: α(1→4) glucosidic bonds/α(1→6) bonds=(100%−%(α(1→6) bonds))/%(α(1→6) bonds)). For example, amylopectin obtained from regular barley may contain 4.5% branching (i.e. %(α(1→6) bonds)), corresponding to a α(1→4)/α(1→6) ratio of 21. Molecules of amylose in general weigh in the range of 104 to 107 g/mol. In a preferred embodiment, at least 95% of the molecules of amylose comprised within the amylose composition of the disclosure have molecular weights falling within the range 104 to 107 g/mol.

Amylopectin from different sources may contain different extends of branching. Accordingly, the ratio of α(1→4) glucosidic bonds to α(1→6) glucosidic bonds and the content of α(1→6) glucosidic bonds compared to the total amount of α(1→6) and α(1→4) glucosidic bonds may relate to, but not necessarily directly translate to amylose content in starch expressed as a w/w%. The ratio of α(1→4) glucosidic bonds to α(1→6) glucosidic bonds and the content of α(1→6) glucosidic bonds may be assessed using a technique such as nuclear magnetic resonance spectroscopy, whereas the content by weight of amylose in starch may be assessed using iodine. Molecules of amylopectin in general weigh in the range of 10⁷ to 10⁹ g/mol.

Provision of Amylose Composition The disclosure provides composite materials comprising the amylose composition described above. In one embodiment of the disclosure, the composite material comprises in the range of 6 to 94% of said amylose composition.

Preferred sources of amylose are plants such as crops. Examples of preferred plants are barley, maize, wheat, potato, rice, cassava, sweet potato, oats, lesser jam, turmeric root, buckwheat, quinoa, rye, black eye bean, chickpea, dry foul bean, ginger, mung bean, pinto, sago, water chestnut, and white kidney bean, or a hybrid of said plants. Thus, one embodiment of the present disclosure provides for a composite materials comprising an amylose composition, wherein the amylose composition is obtained from a plant.

Said amylose composition may be obtained by a method comprising the steps of:
Providing starch containing parts of a plant
Purifying starch from said parts of a plant
Optionally purifying amylose from said starch.

Which parts of a plant contains starch is dependent on the particular plant. The skilled person is well aware of which parts of a plant contains starch. For example, if the plant is a cereal, the starch containing parts is typically the grains of said cereal.

The starch may be purified from said starch containing parts of a plant by any useful method known to the skilled person. For example, the starch containing parts of the plant may be finely divided, e.g. by shearing, grinding, cutting or milling. The finely divided plant parts may then be incubated with an aqueous solution. Said aqueous solution may comprise one or more compounds, e.g. reducing compounds, such as DTT, detergents such as SDS, or alkali such as NaOH. Optionally, the suspension of finely divided plant parts and aqueous solution may be treated, e.g. by stirring and/or homogenisation. After incubation, starch will typically be present as solid parts, which can be separated from the supernatant by any useful means. The obtained starch may be washed one or more times. Non-limiting examples of useful methods for purifying starch from barley grains are provided in Example 1, method 1 and 2 herein below. The skilled person will understand that the methods described therein can be used for purification of starch from other starch containing plants parts as well.

If the starch comprises a lower level of amylose than required, e.g. the starch has an amylose content lower than 96% and/or comprises more than 1.4% α(1→6) glucosidic bonds, amylose may be further purified from said starch in order to obtain an amylose composition useful for the invention.

In a preferred embodiment, the starch is purified from a plant, wherein the starch of said plant already has a sufficiently high level of amylose, i.e. a level of amylose as described in the section “Amylose composition” herein above. In such cases, the purified starch may directly constitute the “amylose composition”. Examples of plants containing starch with a sufficiently high level of amylose are described below.

Thus, the amylose composition of the disclosure may be obtained from a plant, which produces starch with a higher amylose content than obtainable from ordinary starch or high-amylose starch. Advantages of this approach include elimination of the need to purify amylose from starch.

In general, wild type plants do not produce starch with sufficiently high levels of amylose, and thus the plant may have been modified, e.g. by recombinant methods. Thus in some embodiments, the plant may be a transgenic plant. Alternatively, the plant may have been obtained by random mutagenesis.

In one embodiment, the plant has reduced expression and/or activity of at least one starch branching enzyme. Thus, the plant may have been modified to reduce expression of at least one starch branching enzyme (SBE). Said reduced expression may be reduced expression of mRNA encoding said SBE and/or reduced expression of said SBE itself. Said SBE may for example be any of the SBE described below, e.g. any enzyme classified under EC: 2.4.1.18.

Starch branching enzymes (SBEs, EC: 2.4.1.18, also known as: 1,4-α-glucan branching enzyme; amylopectin branching enzyme; Q-enzyme) are a type of glycoside hydrolase belonging to glycoside hydrolase family 13. They are responsible for the biosynthesis of amylopectin. The action of SBEs both depletes desired amylose and produces undesired amylopectin. Accordingly, inhibition or suppression of SBEs in plants has the potential of forming amylose with little to no content of amylopectin. Thus, one embodiment of the present disclosure provides for a plant which having reduced expression and/or activity of starch branching enzyme.

SBEs fall into two categories, namely SBEI and SBEII. Accordingly, in one embodiment of the disclosure, one or more starch branching enzyme are SBEI or and/or SBEII. SBEIIs further falls in two different categories, namely SBEIIa and SBEIIb. Thus, in one embodiment of the disclosure, the reduced SBE is SBEIIa and/or SBEIIb.

SBEI may for example be SBEI of SEQ ID NO: 1 or a functional homologue thereof sharing at 70%, such as at least 80%, for example at least 90%, such as at least 95% sequence identity therewith.

SBEIIa may for example be SBEIIa of SEQ ID NO: 2 or a functional homologue thereof sharing at 70%, such as at least 80%, for example at least 90%, such as at least 95% sequence identity therewith.

SBEIIb may for example be SBEIIb of SEQ ID NO: 3 or a functional homologue thereof sharing at 70%, such as at least 80%, for example at least 90%, such as at least 95% sequence identity therewith.

In one embodiment, the amylose composition is obtained from a plant, which has been modified to reduce expression of one or more of the following, preferably all of the following:
a. SBEI of SEQ ID NO: 1 or a functional homologue thereof sharing at 70%, such as at least 80%, for example at least 90%, such as at least 95% sequence identity therewith; and
b. SBEIIa of SEQ ID NO: 2 or a functional homologue thereof sharing at 70%, such as at least 80%, for example at least 90%, such as at least 95% sequence identity therewith; and
c. SBEIIb of SEQ ID NO: 3 or a functional homologue thereof sharing at 70%, such as at least 80%, for example at least 90%, such as at least 95% sequence identity therewith.

Reduced expression of SBEs can be achieved using any suitable method such as RNA interference, antisense technology, chemical mutagenesis, mutagenesis by radiation, mutagenesis by natural selection, and/or genome editing. Genome editing includes, but is not limited to, techniques such as transcription activator-like effector nucleases (TALEN), zinc finger nucleases (ZFN) or clustered regularly interspaced short palindromic repeats (CRISPR). Accordingly, one embodiment of the disclosure provides for use of a transgenic plant in which one or more genes encoding SBEs are suppressed using RNA interference, antisense technology and/or genome editing such as TALEN, ZFN, or CRISPR. A further embodiment, provides for a transgenic plant in which all one enzyme of each of the three classes of SBEs (SBEI, SBEIIa, and SBEIIb) are suppressed using RNA interference, antisense technology and/or genome editing such as TALEN, ZFN, or CRISPR. In a preferred embodiment of the disclosure, the gene suppression is achieved using RNA interference. In an even more preferred embodiment of the disclosure, suppression of all three classes of SBEs (SBEI, SBEIIa, and SBEIIb) is achieved using RNA interference.

It is also comprised within the invention, that said plant with reduced expression and/or activity of one or more SBEs may have been generated by non-GMO methods. Thus, said plant may for example have been generated by random mutagenesis followed by selecting plants carrying a mutation in one or more SBEs. Said random mutagenesis may e.g. be chemical mutagenesis or mutagenesis by radiation.

In one embodiment of the disclosure, the plant, e.g. the transgenic plant is a crop, such as a bioengineered grain. In a further embodiment, the transgenic plant is selected from the group consisting of: barley, maize, wheat, potato, rice, cassava, sweet potato, oats, lesser jam, turmeric root, buckwheat, or quinoa. In a preferred embodiment of the disclosure, the transgenic plant is barley.

In a preferred embodiment, the amylose composition is prepared from barley plant, which is the barley plant described in Carciofi et al. BMC Plant Biology 2012, 12:223, or from a barley plant, which has been prepared by the methods described therein. In a preferred embodiment, the amylose composition is prepared as described in Example 1, method 1 or method 2 herein below.

The methods disclosed herein for extraction of amylose from the transgenic plants are considered especially advantageous as they avoid any toxic reagents, and thus have a minimal footprint on the environment.

Alternatively, the amylose composition may be produced from starch by addition of debranching enzymes. Hizukuri et al. (Carbohydrate Resarch, 1987, 94, 205) obtained amylose having an amylopectin content corresponding to an α(1→6) bond content of 0.19-0.37% for a variety of different crops. However, this is also an additional step which must be carried out after extraction of the starch and disruption of the compact starch granules by e.g. hydrothermal treatment. Accordingly, producing high-purity amylose directly in a plant, e.g. in a transgenic plant is advantageous as it reduces the amount of work-up required, which further reduces costs and the environmental footprint. Thus, one embodiment of the present disclosure provides for a plant, e.g. a transgenic plant capable of producing an amylose composition having a high amylose content.

### Provision of Cellulose Nanofibres

The composite material of the present invention comprises cellulose nanofibres (CNF). CNF may reinforce the composite material.

Embodiments comprising a high amount of cellulose nanofibres may have high stress at break, but exhibit low strain at break. Vice versa, embodiments of the disclosure comprising a low amount of cellulose nanofibres may exhibit higher strain at break, but will exhibit higher strain at break. In one embodiment of the disclosure, the composite material comprises 5 to 60% cellulose nanofibres. In a further embodiment of the disclosure, the composite material comprises 5 to 55% cellulose nanofibres. In a further embodiment, the composite material comprises 20 to 55% cellulose nanofibre. In another embodiment, the composite material comprises 15 to 35% cellulose nanofibre. In yet another embodiment, the composite material comprises 40 to 60% cellulose nanofibre.

Said cellulose nanofibres are 400 to 4500 nm in length. Specifically, at least 90% of the cellulose nanofibres have lengths falling within the range of 400 to 4500 nm. Preferably, CNFs are 600 to 4500 nm in length, specifically, CNFs for which 90% of the fibres have lengths falling within the range of 600 to 4500 nm are considered especially useful in the manufacture of the disclosed composite materials. For instance, the CNFs are 600 to 2000 nm in length, specifically, CNFs for which 90% of the fibres have lengths falling within the range of 600 to 2000 nm are considered useful in the manufacture of the disclosed composite materials. For example, the CNFs are at least 400 nm long, specifically, CNFs for which 90% of the fibres have lengths of at least 400 nm are considered useful in the manufacture of the disclosed composite materials.

In particular, the CNFs are at least 600 nm long, specifically, CNFs for which 90% of the fibres have lengths of at least 600 nm are considered useful in the manufacture of the disclosed composite materials. Cellulose nanofibres are typically amorphous and will normally degrade when subjected to nitric acid.

Cellulose nanocrystals have dimensions of 100 to 600 nm and are resistant to degradation by nitric acid. Cellulose nanocrystals are not as useful for the composites of the invention.

The size of the cellulose nanofibres and cellulose nanocrystals can be assessed using electron microscopy in combination with light scattering, for example using a Litesizer 500 particle size distribution analyser.

The CNF may be prepared by any useful method. Typically, they are prepared using methods that aim at preserving as many as possible of the less ordered domains in the cellulose microfibril. For example, said CNF may be prepared using an enzyme-assisted grinding process, which may facilitate control of the CNF length. An example of such as method is described by Cellulose 24, 5431-5442 (2017). Said method results in CNF having lengths in the range of 760-4000 nm and an average CNF diameter of about 8.6 nm. Another example of a useful method is described by Liu et al., Industrial Crops and Products 146, 112201 (2020). Said method may produce a wider range of lengths, 290-4500 nm with a diameter up to in the range of 20 - 25 nm. CNF may also bne prepared as described in Holland et al., Biomacromolecules 2019, 20, 443-453. Preferably, CNF is prepared by extracting CNF as described herein below in Example 1. The skilled person will understand that CNF may be extracted from other sources than sugar beet pulp using the methods of Example 1.

The cellulose nanofibres may be obtained from agrowaste, such as vegetable pulp as outlined herein. Useful vegetable pulps include sugar beet, potato tuber, and carrot. Accordingly, in one embodiment of the present disclosure, the cellulose nanofibres are obtained from agrowaste. In a further embodiment, the cellulose nanofibres are obtained from vegetable pulp. In an even further embodiment of the disclosure, the cellulose nanofibres are obtained from sugar beet pulp, potato tuber pulp, and/or carrot pulp. In a preferred embodiment of the disclosure, the cellulose nanofibres are obtained from sugar beet pulp.

Cellulose nanofibres prepared from vegetable pulp as outlined before is especially advantageous because it is more facile and cleaner than preparation of cellulose nanofibres from wood as raw material. Thus, in one embodiment of the present disclosure, the cellulose nanofibres are prepared from vegetable pulp.

### Plasticiser

Plasticisers are effective to plasticise the composite material disclosed herein as a whole or at least one component of the composite material. In one embodiment of the present disclosure, the plasticiser is a compound, which, in combination with a sufficient amount of an amylose composition, lowers the glass transition temperature thereof. In one embodiment of the present disclosure, the plasticiser is effective at lowering the glass transition temperature of the amylose composition. The plasticiser may alternatively be effective at lowering the crystallinity of the composite material. Thus, in one embodiment of the disclosure, the plasticiser lowers the crystallinity of composite material, compared to the composite material as a whole, or compared to any one of the components constituting said composite material. Additionally, the plasticiser may decrease brittleness and result in enhanced flexibility upon being incorporated in a polymer. Accordingly, in one embodiment of the present disclosure, the plasticiser is effective at lowering the brittleness and/or increasing the flexibility of the disclosed composite materials.

In some embodiments, the plasticiser is effective to plasticise the amylose. In another embodiment, the plasticiser is effective to plasticise the cellulose nanofibres. In another embodiment, the plasticiser is effect to plasticise the cellulose nanocrystals. In the preferred embodiment of the present disclosure, the plasticiser is effective at plasticising a composite material comprising amylose and cellulose nanofibres or cellulose nanocrystals.

The plasticisers are typically low molecular weight, relatively non-volatile molecules that dissolve in a polymer, separating the chains from each other and hence facilitating reptation and reducing the glass transition temperature of the composition. However, the plasticiser may also be high-molecular weight polymers. In one embodiment of the disclosure, the plasticizer is miscible primarily with amylose, cellulose nanofibres, and/or cellulose nanofibres.

Plasticisers include for example: adipic acid derivatives, such as tridecyl adipate; benzoic acid derivatives, such as isodecyl benzoate; citric acid derivatives, such as tributyl citrate; glycerol itself and derivatives thereof; phosphoric acid derivatives, such as tributyl phosphate; polyesters; sebacic acid derivatives, such as dimethyl sebacate; urea. The plasticiser may also be a monosaccharide or a disaccharide, such as sorbitol. Alternatively, the plasticiser is an oligosaccharide, or a polysaccharide. The plasticiser may also be glycerol. Thus, in one embodiment of the present disclosure, the plasticiser comprises an adipic acid ester. In another embodiment, the plasticiser comprises a benzoic acid ester. In another embodiment, the plasticiser comprises a citric acid ester. In another embodiment, the plasticiser comprises glycerol or an alkylated glycerol. In another embodiment, the plasticiser comprises a phosphoric acid ester. In another embodiment, the plasticiser comprises a polyester. In another embodiment, the plasticiser comprises sebacic acid ester. In another embodiment, the plasticiser comprises a monosaccharide. In another embodiment, the plasticiser comprises a disaccharide. In another embodiment, the plasticiser comprises an oligo saccharide. In another embodiment, the plasticiser comprises a polysaccharide. In a preferred embodiment of the disclosure, the plasticiser is selected from the list consisting of tridecyl adipate, isodecyl benzoate, tributyl citrate, glycerol, tributyl phosphate, dimethyl sebacate, urea, a polysaccharide, an oligo saccharide, a disaccharide, or a monosaccharide. In an even further embodiment of the disclosure, the plasticiser comprises glycerol or sorbitol. In a most preferred embodiment of the disclosure, the plasticiser is glycerol or sorbitol.

Composite materials consisting of amylose and a cellulose nanofibre or cellulose nanocrystal may be too brittle for several different types of applications. Accordingly, the composite material of the present disclosure preferably comprises a plasticiser in order to reduce the brittleness and increase the flexibility of the composite material. Thus, in one embodiment of the disclosure, a composite material is provided comprising 1 to 40% plasticiser. In a further embodiment, the composite material comprises 5 to 40% plasticiser, such as 10 to 30% plasticiser, such as 15 to 25% plasticiser.

Incorporation of plasticiser into a composite material can lower the strength, such as the tensile strength of such material. Accordingly, dependent on the use of the composite material, there may an optimal amount of plasticiser comprised within the composite material whereby the composite material has sufficient flexibility, while also having a sufficient strength, such as tensile strength. Thus, in one embodiment of the present disclosure, the composite material comprises 1% to 10% plasticiser. In another embodiment of the disclosure, the composite material comprises 5% to 15% plasticiser. In another embodiment of the disclosure, the composite material comprises 10% to 20% plasticiser. In another embodiment of the disclosure, the composite material comprises 15% to 25% plasticiser. In another embodiment of the disclosure, the composite material comprises 20% to 30% plasticiser. In yet another embodiment, the composite material comprises 25% to 35% plasticiser. In a final embodiment, the composite material comprises 30% to 40% plasticiser. In a preferred embodiment of the present disclosure, the composite material comprises 10% to 30% plasticiser. For many purposes, tensile strength can be sacrificed to obtain a composite material having higher flexibility by incorporation of comparatively more plasticiser. Vice versa, flexibility of a composite material as disclosed herein can be sacrificed in exchange for higher tensile strength by incorporation of comparatively less plasticiser.

### Properties of the Composite Material

The composite material of the present disclosure exhibits optimal physical and mechanical properties for its intended purpose.

In particular, the composite material has an optimal wettability. Wettability of a material is an indication of the hydrophilicity and/or the hydrophobicity of the bulk material. Wettability is reflected in the water contact angle of the material, which can be assessed using a KSV Cam 200 (KSV Instruments Ltf, Helsinki, Finland. In one embodiment of the present disclosure, the composite material as disclosed herein may have a water contact angle of 40° to 120°. In another embodiment of the present disclosure, the composite material as disclosed herein may have a water contact angle of at least 55°, preferably at least 60°, even more preferably at least 65°.

The composite material as disclosed herein exhibits good mechanical properties. For instance, one embodiment of the present disclosure provides for a composite material as disclosed herein having a Young's modulus of at least 1000 MPa. For many of the intended applications as outlined herein, it is advantageous that the strength of the composite material is below a certain limit. Such applications may require that the material is cut open by using a cutting tool such as a pair of scissors, a knife, or a fork, or that the material is torn open using a blunt tool such as a kitchen utensil. Alternatively, the user is able to tear the composite material using their hands. Accordingly, in a further embodiment of the present disclosure, the composite material may have a Young's modulus in the range of 1000-10000 MPa. In a further embodiment of the disclosure, the composite material may have a Young's modulus of in the range of 1500-9000 MPa, such as in the range of 2000-8000 MPa. As outlined herein, the strength of the composite material, such as the Young's modulus of the material, may be modified by incorporation of plasticiser.

The composite material as disclosed herein exhibits some degree of elasticity. In particular, for many purposes it is advantageous that the composite material is flexible so that it elongates rather than breaks or shatters when subjected to an external force. In one embodiment of the present disclosure, the composite material exhibits a strain at break of 1 to 18%.

The composite material as disclosed herein exhibits good tensile properties. Accordingly, one embodiment of the present disclosure provides a composite material exhibiting a stress at break of 5-60 MPa. Stress at break can be assessed as outlined in ISO 527-2(2012) and ASTM D882(2018).

The composite material of the present disclosure may for example be useful for packaging or sealing of produce, which may spoil if subjected to its surroundings. In particular, the produce may spoil if subjected to oxygen or water. Additionally, certain produce is packaged under an atmosphere of carbon dioxide to keep produce fresh, and accordingly it is advantageous that packages for such produce does not leak.

Thus, in one embodiment of the present disclosure, the composite material of the disclosure has a permeability to O₂ of less than 100 cm³·mm/(m²·kPa·24 h). In further embodiments of the disclosure, the composite material has a permeability to O₂ of less than 60 cm³·mm/(m²·kPa·24 h), such as less than 40 cm³·mm/(m²·kPa·24 h), such as less than 30 cm³·mm/(m²·kPa·24 h), such as less than 20 cm³·mm/(m²·kPa·24 h). In a preferred embodiment of the disclosure, the composite material as disclosed herein has a permeability to O₂ of less than 20 cm³·mm/(m²·kPa·24 h). In another embodiment of the disclosure, the composite material has a permeability to CO₂ of less than 100 cm³mm/(m²·kPa·24 h). In a further embodiment of the disclosure, the composite materials has a permeability to CO2 less than 60 cm³·mm/(m²·kPa·24 h), such as less than 40 cm³·mm/(m²·kPa·24 h), such as less than 30 cm³·mm/(m²·kPa·24 h), such as less than 20 cm³·mm/(m²·kPa·24 h). In a preferred embodiment of the disclosure, the composite material as disclosed herein has a permeability to CO₂ of less than 20 cm³·mm/(m²·kPa·24 h). In another embodiment of the present disclosure, the composite material has a permeability to water of less than 30 cm³·mm/(m²·kPa·24 h). In a further embodiment of the disclosure, the composite material has a permeability to water of less than 10 cm³·mm/(m²·kPa·24 h), such as less than 5 cm³·mm/(m²·kPa·24 h), such as less than 1 cm³·mm/(m²·kPa·24 h), such as less than 0.3 cm³·mm/(m²·kPa·24 h). In a preferred embodiment of the disclosure, the composite material as disclosed herein has a permeability to water of less than 0.3 cm³·mm/(m²·kPa·24 h).

The specific gelatinisation temperature of the disclosed composite material makes it especially useful for procedures such as wet spinning or film casting at temperatures over 120° C. Including of cross-linkers and plasticisers in the composite material is compatible with these procedures. Suitable cross-linkers include, but are not limited to, maleic acid and adipic acid dihydrazide.

In one embodiment the material has a tensile strength of at least 100 MPa, such as of at least 150 MPa, for example at least 175 MPa, such as in the range of 150 to 1000 MPa, for example in the range of 150 to 500 MPa, such as in the range of 150 to 400 MPa, for example in the range of 150 to 300 MPa.

### Producing Composite Material

The composite material according to the invention may be produced by any useful method. For example, the composite material may be produced by a method comprising the steps of:
a. Providing an amylose composition, wherein said amylose composition for example be may any of the amylose compositions described herein above in the section “Amylose composition”;
b. Providing cellulose nanofibres (CNF) or cellulose nanocrystals (CNC), wherein said CNF for example may be any of the CNFs described herein above in the section “Provision of cellulose nanofibres”;
c. Providing a plasticiser, wherein said plasticiser composition for example be may any of the plasticisers described herein above in the section “plasticiser”;
d. mixing said amylose composition, said cellulose nanofibre or cellulose nanocrystal, and said plasticiser, and
e. heating said mixture to obtain said composite material.

Preferably, said amylose composition, said cellulose nanofibre or cellulose nanocrystals, and said plasticiser are mixed in a ratio, so that the composite material comprises said components in the amounts indicated herein above in the sections “Composite material”, “Provision of amylose composition”, “Provision of cellulose nanofibres” and “Plasticiser”.

Said amylose composition may be provided in an aqueous solution, i.e. the amylose composition may be dissolved or suspended in water, e.g. in a concentration of amylose composition in the range of 0.1 to 10%, such as in the range of 0.5 to 5%. Aforementioned purity of the amylose composition relates to the dry composition, i.e. without water.

Said CNF may be provided as an aqueous suspension of either never-dried CNF or dried, reconstituted CNF at a final concentration in the range of e.g. 0.1 to 10%, such as in the range of 0.5 to 5%.

Said CNC may be provided as an aqueous suspension of CNC at a final concentration in the range of e.g. 0.1 to 10%, such as in the range of 0.5 to 5%.

Heating of step d. may be heating to a temperature in the range of 100 to 200° C., such as in the range of 120 to 160° C., for example in the range of 130 to 150° C. Heating may be performed for in the range of 15 to 60 min, such as in the range of 25 to 45 min.

Said heating may be performed in a closed container, which will typically lead to a high pressure.

After heating the mixture may be cooled and/or degassed at low pressure, e.g. in vacuum, after which the mixture may be cast in the desirable shape.

In a specific embodiment of the present disclosure, mixing of said amylose composition and CNF or CNC is carried out at high shear in a homogeniser, e.g. a Gaulin-type homogeniser or a microfluidizer as provided by Microfluidics (USA).

### Composting

The composite materials disclosed here are biodegradable, such as compostable. Industrial-scale composting may rely on heating in order to improve the rate and/or extent of degradation of the materials composted. The majority of home composting facilities do not make use of heating, and accordingly, many bioplastics are not readily compostable in such home composters. The composite materials of the present disclosure are especially suitable for being degraded in composters, which do not actively heat the materials composted. Thus, in one embodiment of the present disclosure, the composite material of the disclosure is biodegradable, such as compostable. In a preferred embodiment of the disclosure, the composite material is compostable in a home composter.

The extent to which a material degrades under conditions similar to those present in a home composter can be assessed using the method outlined in Sagnelli et al., International Journal of Molecular Sciences, 2017, 18(10), 2075. In one embodiment of the present disclosure, the composite material of the disclosure is capable of being degraded in a home composter such that at least 50% of the material by weight is degraded after 100 days. In a further embodiment, the composite material of the disclosure is capable of being degraded in a home composter such that at least 75% of the material by weight is degraded after 100 days. In a preferred embodiment, the composite material is capable of being degraded in a home composter such that at least 90% of the material by weight is degraded after 100 days, such as at least 95% of the material, such as at least 99% of the material.

Bioplastics with proven compostability according to international standards may be treated in industrial composting plants. Plastic products can provide proof of their compostability by successfully meeting the harmonised European standard, EN 13432 and/or EN 14995. The composite material of the disclosure is preferably compostable in an industrial composting facility. Accordingly, in one embodiment of the disclosure, the composite material of the disclosure meets the harmonised European standard EN 13432. In another embodiment of the disclosure, the composite material of the disclosure meets the harmonised European standard EN 14995.

### Uses of the Composite Material

The composite materials disclosed herein are biodegradable, such as compostable. Accordingly, they are suitable for applications which use composite materials that are disposed of after use, such as after few uses or after a single use. In one embodiment of the present disclosure, the composite material is used to manufacture a packaging. In a preferred embodiment of the disclosure, the composite material is used to manufacture a food packaging.

Sequences

SEQ ID NO: 1: Starch Branching Enzyme I from Hordeum vulgare
SKLSLPVSAPRDFTMATAQDGADDLPIYDLDPKFAGFKDHFSYRMKKYRDQKHLIDEHEGGLEEFSKGYL
KFGINTENDATVYREWAPAAKEAQVIGDFNNWNGSGHRMTKDNFGVWSIRISHVNGKPAIPHNSKVKFRF
HRGDGVWVDRIPAWIRYAIADASKFGAPYDGVHWDPPTSERYVFKHPRPQKPDAPRIYEAHVGMSGEKPE
VSTYREFADNVLPRVKANNYNTVQLMAIKEHSYYASFGYHVTNFFAASSRSGTPEDLKYLVDKAHSLGLR
VLMDVVHSHASSNMTDGLNGYDVGQNTQESYFHTGERGYHKLWDSRLFNYANWEVLRFLLSNLRYWMDEF
MFDGFRFDGVTSMLYNHHGINMSFSGDYKEYFGLDTDVDAVVYMMLANHLMHKLLPEATIVAEDVSGMPV
LCRSVDEGGVGFDYRLAMAIPDRWIGYLKNKDDLEWSMSGIAHTLTNRRYTEKCIAYAESHDQSIVGDKT
MAFLLMDKEMYTGMSDLQPASPTIDRGIALQKMIHFITMALGGDGYLNFMGNEFGHPEWIDFPREGNNWS
YDKCRROWSLVDIDHLRYKYMNAFDQAMNALDDKFSFLSSSKQIVSDMNEEKKVIVFERGDLVFVFNFHP
NKTYDGYKVGCDLPGKYKVALDSDALMFGGHGRVAHDSDHFTSPEGIPGVPETNFNNRPNSFKILSPPRT
CVAYYRVEEKAEKPKDGGAAFWGKLLRDTSMLKLLASKDATDGEAISGSEKVSTGDGSVKRGINFVFRSP
DKDNK
SEQ ID NO: 2: Starch Branching Enzyme IIa from Hordeum vulgare
MAEVNMTGGAAEKLESSEPTQGIAETITDGVTKGVKELVVGEKPQVVPKPGDGQKIYEIDPTLKDFRSHL
DYRYSEYKRIRAAIDQHEGGLEVFSRGYEKLGFTRSAKGITYREWAPGAHSAALVGDENNWNPNADTMTR
DDYGVWEIFLPNNADGSPAIPHGSRVKIRMDTPSGVKDSISAWIKFSVQAPGEIPFNGIYYDPPEEEKYV
FQHPQPKRPESLRIYESHIGMSSPEPKINSYANFRDEVLPRIKRLGYNAVQIMAIQEHSYYASFGYHVTN
FFAPSSRFGTPEDLKSLIDRAHELGLLVLMDIVHSHSSNNTLDGLNGFDGTDTHYFHGGPRGHHWMWDSR
LFNYGSWEVLRFLLSNARWWLEEYKFDGFRFDGVTSMMYTHHGLQMTFTGNYGEYFGFATDVDAVVYLML
VNDLIHGLYPDAVSIGEDVSGMPTFCIPVPDGGVGFDYRLHMAVADKWIELLKQSDESWKMGDIVHTLTN
RRWLEKCVTYAESHDQALVGDKTIAFWLMDKDMYDFMALDRPSTPRIDRGIALHKMIRLVTMGLGGEGYL
NFMGNEFGHPEWIDFPRGPQTLPTGKVLPGNNNSYDKCRRRFDLGDADFLRYRGMQEFDQAMQHLEEKYG
FMTSEHQYVSRKHEEDKVIIFERGDLVFVFNFHWSNSKKDYRVGCSKPGKYKVALDSDDALFGGFSRLDH
DVDYFTTEHPHDNRPRSFSVYTPSRTAVVYALTE
SEQ ID NO: 3: Starch Branching Enzyme IIb from Hordeum vulgare
MAAPAFAVSAAGIARPSARRSSGAEPRSLLFGRNKGTRFPRAVGVGGSGWRVVMRAGGPSGEVMIPDGGS
GGSGTPPSIEGSVQFESDDLEVPFIDDEPSLHDGGEDTIRSSETYQVTEEIDAEGVSRMDKESSTVKKIR
IVPQPGNGQQIYDIDPMLRDFKYHLEYRYSLYRRIRSDIDEYDGGMDVFSRGYEKFGFVRSAEGITYREW
APGADSAALVGDFNNWDPTADHMSKNDLGIWEIFLPNNADGSPPIPHGSRVKVRMDTPSGTKDSIPAWIK
YSVQTPGDIPYNGIYYDPPEEEKYVFKHPQPKRPKSLRIYETHVGMSSPEPKINTYANFRDEVLPRIKRL
GYNAVQIMAIQEHSYYGSFGYHVTNFFAPSSRFGSPEDLKSLIDRAHELGLLVLMDVVHSHASSNTLDGL
NGFDGTDTHYFHGGSRGHHWMWDSRVFNYGNKEVIRFLLSNARWWLEEYKFDGFRFDGATSMMYTHHGLQ
VTFTGSYHEYFGFATDVDAVVYLMLVNDLIHALYPEAVTIGEDVSGMPTFALPVQVGGVGFDYRLHMAVA
DKWIELLKGSDEGWEMGNIVHTLTNRRWLEKCVTYAESHDQALVGDKTIAFWLMDKDMYDFMALNGPSTP
NIDRGIALHKMIRLITMALGGEGYLNFMGNEFGHPEWIDFPRGPQVLPTGKFIPGNNNSYDKCRRRFDLG
DAEFLRYHGMQQFDQAMQHLEEKYGFMTSDHQYVSRKHEEDKVIVFEKGDLVFVFNFHWSNSYFDYRVGC
LKPGKYKVVLDSDAGLFGGFGRIHHTGEHFTNGCQHDNRPHSFSVYTPSRTCVVYAPMN

### EXAMPLES

### Example 1

### Production of Composite Films

### Materials

Sugar beet pulp was provided as an agro-industrial side stream by Nordic Sugar A/S. CNF (85%) was extracted as described below. AM (99% compared to the total amount of amylose and amylopectin in said amylose composition) was prepared as described elsewhere from a starch branching enzyme RNA interference suppressor barley line (Carciofi, Blennow, Nielsen, Holm, and Hebelstrup, Plant Methods, 2012, 8(1)). All chemicals were provided by Sigma-Aldrich (St. Louis, Mo., USA).

### Extraction of AM

Amylose was extracted from barley using one of the following methods:

### Method 1:

Barley flour was mixed at a ratio of 1:10 with a solution containing 1 mM dithiotreitol (DTT) and 0.5% SDS (sodium dodecyl sulphate). The suspension was homogenized at 5700 rpm using a Silverson L5A homogenizer with the largest slit size for 10 min and then at 8300 rpm for 20 min. The starch granules were sedimented at 4° C. over night or until the supernatant was visually clear. The supernatant was carefully discarded, and the starch-containing sediment washed with MilliQ water three times and sieved through a 100 μm mesh. The starch was collected and washed again with MilliQ water. A white layer consisting of starch granules was collected and dried at room temperature. The extracted amylose contained 0.36% α(1→6) bonds compared to the total amount of α(1→6) and α(1→4) bonds, corresponding to an α(1→4)/α(1→6) ratio of 277.

### Method 2:

Barley amylose grains (100 g, dry base) were grinded by an electric grinder, and mixed with 500 mL of 0.075 M aqueous sodium hydroxide (NaOH) and stirred at 25° C. for 3 h, after which it was collected by centrifugation (5500 g , 15 min). The supernatant was discarded, and the yellow-brown layer of the sediment was removed with a spatula. This alkali washing was done three times. After washing with alkali, the starch residue was again suspended in water (500 mL), filtered through a 100-mesh screen. The starch residue was washed again and then left in water for neutralization to pH 7.0 by adding 1 M hydrochloric acid (HCl). Finally, starch was collected and washed with ethanol 97%, leaving it to dry at room temperature.

### Extraction of Cellulose Nanofibres

Cellulose nanofibres (CNF) were prepared from sugar beet pulp as follows: 20 g (dry weight) of sugar beet was added to 2500 mL distilled water (dH₂O) and homogenized to pulp (particle sizes around 1 mm) with a Silverson L5A homogenizer (East Longmeadow, Ma., USA) at 5600 rpm for 10 min and thereafter at 8300 rpm for 20 min using a slotted disintegrating head. The pulp was subsequently washed with 5000 mL of dH₂O though a 38 pm sieve and then suspended in 500 mL 0.5 M NaOH, stirred at 80° C. for 2 h, and washed until neutral with dH₂O. The NaOH-treated pulp was submerged in 500 mL bleach solution (1% NaClO₂ and pH 5.0), stirred at 70° C. for 2 h, and washed with dH₂O. After obtaining the dry weight of the remaining suspension of cellulose fibres, it was diluted to 1.00% (w/w) in 200 mL dH₂O. The cellulose fibres (200 mL) were circulated in a high-shear homogenizer (microfluidizer materials processor M110-P, Newton, Ma., USA) with orifices of 200 and 400 μm under 500 bar pressure for 18 min to produce nanofibers (CNF). The nanofibers (CNF) were stored at 4° C.

### Casting of Composite Films

The different nanocomposite formulations of AM and CNF with different glycerol content were prepared as outlined below. The CNF:AM ratios were 0:100, 25:75, 50:50, and 100:0 (w/w %). All constituents (1% aqueous solutions each of CNF and AM and different glycerol concentrations) were heated while stirring for 30 min at 140° C. using a high-pressure glass reactor. The solutions were cooled to approximately 70° C., degassed in vacuum and immediately cast in Teflon-coated petri dishes. The films were dried at 50° C. in a ventilated oven overnight or until completely dry and transparent. The films were equilibrated for three days in a desiccator containing a saturated solution of potassium chloride (RH 85, 20° C.) before the analysis. The samples discussed herein are named using the format X/Y/Z to indicate the content of the different components. Specifically, X indicates the amount of glycerol, Y indicates the amount of CNF, and Z indicates the amount of AM. Accordingly, the composition contains X % glycerol by weight, with the remaining content being CNF and AM in a ratio of Y:Z (w/w %). For example, 15/25/75 designates a sample containing 15% glycerol with the remaining 85% of the content being CNF and AM in a ratio of 25:75 CNF:AM (w/w %).

### Example 2

### Gelatinisation Profile of AM

### Method

The gelatinisation profile of AM was monitored using a rheometer (Anton Paar, Ireland, MCR102) equipped with a leak-proof pressure cell and a Rapid Visco Analyzer (RVA) vane geometry (Anton Paar, Ireland, ST24-4V-2D). A 10% w/w suspension of AM was prepared in triplicate. The experiment was performed using the following program: mixing at 960 rpm for 90 s at 50° C., pasting at 170 rpm, by a temperature ramp from 50° C. to 145° C. at a rate of 2° C./min, an isotherm at 145° C. for 30 min, a cooling ramp from 145° C. to 50° C. at a rate of 3° C./min.

### Results

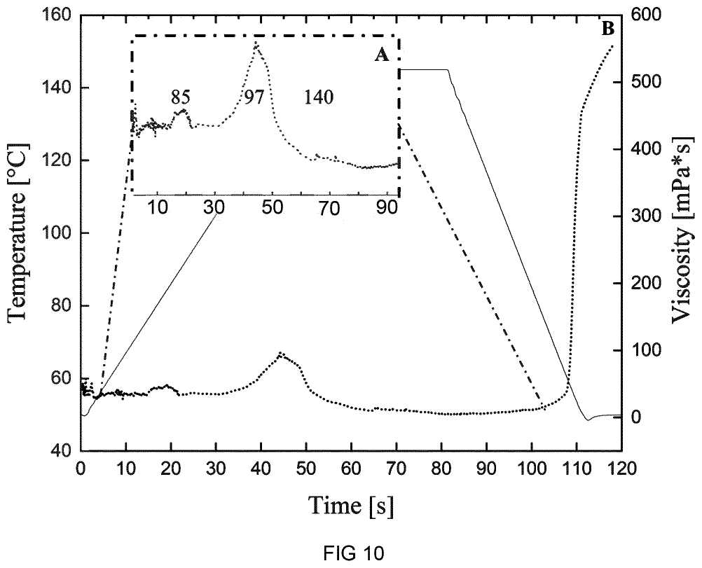

Prior to the production of the bio-nanocomposites, the gelatinisation behavior of AM in a high-pressure rheometer was tested. We recorded three different transitions for 10% w/w AM/water suspensions. The first transition was detected at 87° C., indicating that the granules were starting to swell and take up water (FIG. 10). The main transition was detected at 97° C. indicating the melting and gelatinization of the granules (FIG. 10). The last transition was detected at 140° C. showing the melting of AM/lipid complexes (FIG. 10). These data agree with melting profiles for this starch measured by differential scanning calorimetry (Sagnelli, Hebelstrup, Leroy, Rolland-Sabate, Guilois, Kirkensgaard, Mortensen, Lourdin, and Blennow, Carhydr Polym, 2016, 152, 398). As guided by these data, we set the temperature for gelatinization of the AM in the suspensions to secure complete dissolution of all crystallites prior of the casting phase.

### Example 3

### Confocal Laser Scanning Microscopy (CLSM)

### Methods

The films were analyzed by CLSM (Leica SP5-X, Leica Microsystems, IL, USA) equipped with x20 water immersion objectives. Pontamine Fast Scarlet 4BS (PFS 4BS) and safranin O (Sigma-Aldrich) were used as fluorophores for CNF and AM starch, respectively. The excitation fluorescence were 488 nm and 488 nm and emitted fluorescence were recorded between 207 560-605 nm and 530-550 nm, respectively, for PFS and safranin O. Images analysis was performed with LAS AF X 2.6 software (Leica Microsystems, Ill., USA).

### Results

The internal structure of the films was analyzed by CLSM (Chen, Yu, Simon, Petinakis, Dean & Chen, Journal of Cereal Science, 2009, 50(2), 241) using two different fluorophores, safranin O and PFS 4BS (Anderson, Carroll, Akhmetova & Somerville, Plant Physiol. 2010, 152(2), 787; Durrenberger, Handschin, Conde-Petit & Escher, LWT—Food Science and Technology, 2001, 34(1), 11) permitting identification of starch and cellulose domains, respectively (FIG. 2). The pure AM and CNF films displayed virtually homogeneous internal phases as evaluated by the safranin O and PFS 4BS staining, respectively. No cross-contamination with starch or cellulose of these pure films was detected. Phase partitioning between CNF and AM was readily detected in the 0/25/75 and 0/50/50 films as separated bright and dark fields representing safranin O-stained AM and PFS 4BS stained CNF domains. These results clearly suggest a partial phase separation between AM and CNF. The same phenomenon was observed for nanocomposites of starch and betaglucans (Sagnelli et al., Carbohydr. Polym, 2017, 172, 237).

### Example 4

### Field Emission Scanning Electron Microscopy

### Methods

FE-SEM images were acquired with a Quanta 3D FEG (FEI company, The Netherlands). The films were cut into squares (1×1 cm), attached to a metal plate, and coated with a 2 nm colloidal gold layer before analysis.

### Results

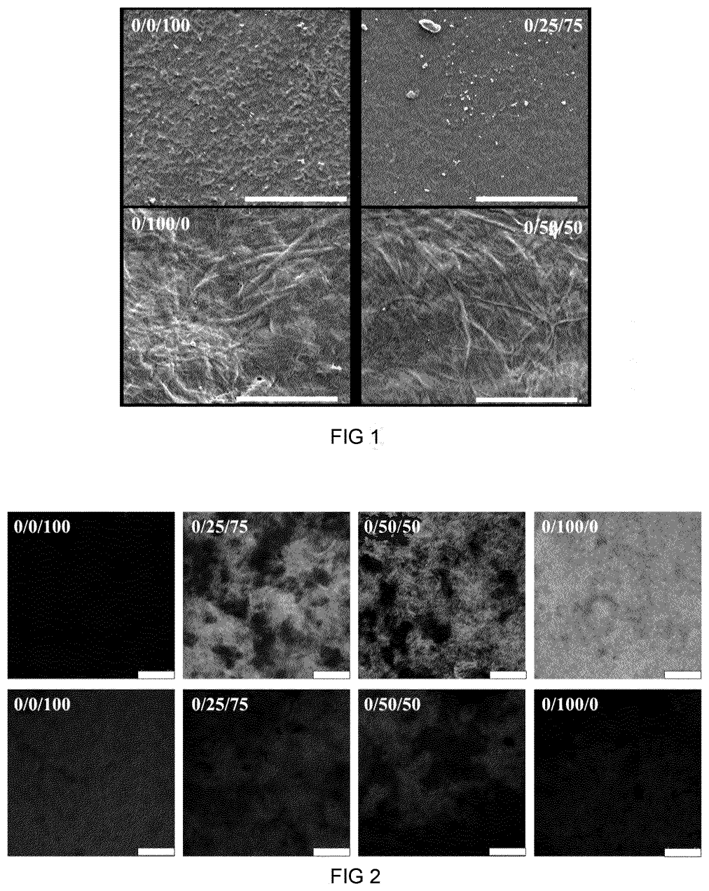

The FE-SEM surface analysis of films produced from AM and CNF at different ratios showed that the topography changed significantly with increasing CNF content (FIG. 1). The 0/0/100 (pure AM) film surface showed numerous pleated structures. CNF blended to 25% resulted in a smoother surface indicating an interaction between the two polysaccharides where the CNF are located internally and coated by AM. When CNF content was raised to 50% and 100% fibre-like structures became visible on the surface of the films. The films plasticized with glycerol showed no significant differences as compared to the non plasticized films.

### Example 5

### Water Contact Angles (Θw)

### Methods

Water contact angles (Θw) of films were performed at room temperature with a KSV Cam 200 (KSV Instruments Ltd, Helsinki, Finland) and angle pictures were recorded by using the built-in software (CAM200, KSV instruments). All measurements were recorded in duplicates.

### Results

The water contact angle (Θw) is defined as the angle formed by the intersection of the tangent lines of the liquid and surfaces of the solid at the three-phase boundary (generally liquid, solid and air) (Wong, Gastineau, Gregorski, Tillin & Pavlath, Journal of Agricultural and Food Chemistry, 1992, 40(4), 540). The water contact angle provides information related to the degree of hydrophilic/hydrophobic nature of a surface, and is indicative of the surface wettability as well as the strength of the molecular interaction among liquid, solid, and air phases (Gutiérrez, 011ier & Alvarez, 2018). The water contact angle increases with increased surface hydrophobicity. A Θw lower than 65° is regarded as a hydrophilic surface, while a Θw higher than 65°, suggests a hydrophobic surface (Gutiérrez, Ollier & Alvarez, Surface Properties of Thermoplastic Starch Materials Reinforced with Natural Fillers, 2018, pp. 131-158; Karbowiak, Debeaufort, Champion & Voilley, J. Colloid Interface Sci., 2006, 294(2), 400-410; Vogler, Advances in Colloid and Interface Science, 1998, 74(1), 69). Polysaccharides typically show relatively high Θw, which is suggested to be related to strong intermolecular hydrogen bonding among the hydroxyl groups of the polysaccharide backbone with the surface of films (Karbowiak, Debeaufort, Champion & Voilley, J. Colloid Interface Sci. 2006, 294(2), 400; Ojagh, Rezaei, Razavi & Hosseini, Food Chemistry, 2010, 122(1), 161). The Θw values of the composite films were affected in various degrees by the AM: CNF ratios and glycerol (Table 1). Without glycerol, CNF decreased the Ow value suggesting strong positive effect of CNF on the surface wettability. The water contact angles of 0/50/50 and 0/100/0 were lower than 65°, indicating the CNF decreased intermolecular hydrogen bonding in the polysaccharide composite matrix. Pure AM and 0/25/75 (75% AM) films showed a water contact angle≥65° suggesting low wettability of these composites. Addition of 15% glycerol 357 to the AM film showed little effect. However, when both CNF and glycerol were included, the water contact angle increased, suggesting glycerol-induced increase in intramolecular bonding in the composite.

With a high (25%) glycerol concentration, the AM films showed a notable increase in Θw suggesting the presence of strong intermolecular hydrogen bonding between glycerol and AM in the AM matrix and the presence of specific AM-glycerol structures (Karbowiak, Debeaufort, Champion & Voilley, J. Colloid Interface Sci. 2006, 294(2), 400). On the other hand, high glycerol concentration in the AM/CNF composites showed a significant variability in Ow. There was a drop in contact angle of film 25/25/75 which we suggest is due to a decrease of the intermolecular hydrogen bonding network.

TABLE 1
Moisture, crystallinity, and contact angle
of AM/CNF pure and composite films.

| | Moisture | Crystallinity | Contact angle |
|---|---|---|---|
| Composition | (%) | (%) | (deg) |
| 0/0/100 | 12.08 | 14 | 87.0 ± 1.0 |
| 0/25/75 | 13.67 | 18 | 67.0 ± 1.0 |
| 0/50/50 | 9.58 | 23 | 58.0 ± 1.0 |
| 0/100/0 | 7.23 | 40 | 55.0 ± 1.0 |
| 15/0/100 | 12.87 | 15 | 90.0 ± 1.0 |
| 15/25/75 | 16.15 | 12 | 87.0 ± 1.0 |
| 15/50/50 | 13.12 | 34 | 74.0 ± 1.0 |
| 15/100/0 | 14.74 | 57 | 81.0 ± 1.0 |
| 25/0/100 | 15.83 | 18 | 111.0 ± 1.0 |
| 25/25/75 | 12.41 | 20 | 46.0 ± 1.0 |
| 25/50/50 | 15.56 | 43 | 100.0 ± 1.0 |
| 25/100/0 | 14.34 | 55 | 60.0 ± 1.0 |

### Examples 6

### Attenuated Total Reflectance Fourier-Transform Infrared (ATR-FTIR) Spectroscopy

### Methods

ATR-FTIR spectra were acquired with an attenuated total reflection spectrophotometer (Agilent Technologies Cary 630 FTIR, Santa Clara Calif., USA) equipped with reflection ATR unit. Spectra were acquired with a resolution of 4 cm⁻¹, in the range 4000-650 cm⁻¹ by acquiring 32 interferograms. Spectra were analyzed with the open access software SpectraGryph1.2.

### Results

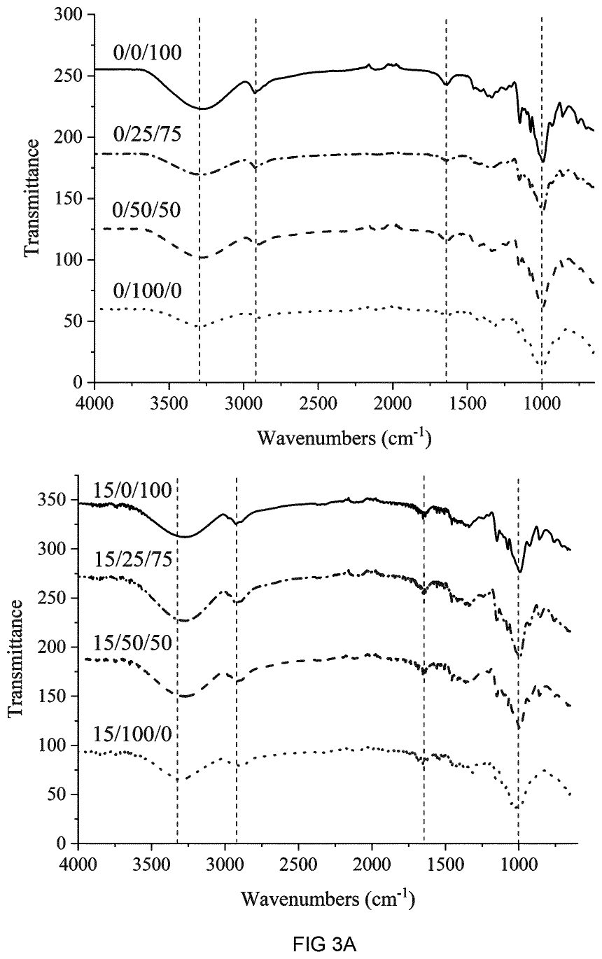

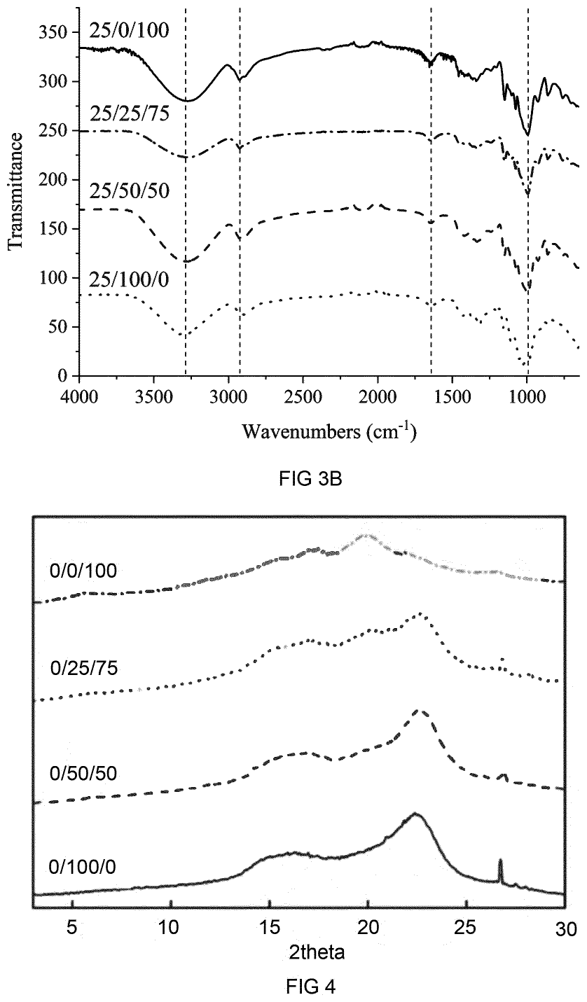

FTIR was conducted in order to test if new chemical bonds or physical interactions (mainly H-bonding) were formed during the processes. The ATR FTIR spectra (FIG. 3) showed that the O—H stretching, corresponding to a broad band between 3600-3200 cm⁻¹, due to an extensive H-bonding network among the OH of starch glycerol and cellulose. The C—H stretching was observed at 2900 cm⁻¹. The appearance of an absorption band at 1650 cm⁻¹ is attributed to the water adsorbed, due to the hygroscopic nature of polysaccharides. The peaks at 1050 to 950 cm⁻¹, related to the C—O—C stretching showed a slight shift towards higher wave number for the CNF-containing films demonstrating an additive effect of CNF. Otherwise, all the spectra were very similar and hence, we conclude that no new covalent bonds formed between AM and CNF. As deduced from FTIR glycerol had only minor effects on the bonding network of the films (FIG. 3).

### Example 7

### Wide Angle X-ray Scattering (WAXS)

### Methods

The pure component and composite films were placed in a sealed desiccator containing saturated potassium chloride (RH 85, 20° C.) to balance the moisture before analysis. Collection of data was performed using a Panalytical Xpert Pro (Nottingham, UK) instrument. The samples were tested in the WAXS (wide-angle X-ray scattering) mode and the intensity given according to q=4 π sinθ/λ, where λ is the wavelength and 2θ is the scattering angle set from 5° to 35°. The exposure time was 400 s/step with a step increment of 0.0131303°.

### Results

AM/CNF pure and composite films were found to possess well-defined crystalline structures as deduced by wide angle X-ray scattering (VVAXS) (Table 1 and FIG. 4). The AM films exhibited a typical V-type polymorph mainly formed by single-helices (Xu, Tan, Chen, Li & Xie, 2019) as demonstrated by diffraction peaks at 2θ of 5.5°, 16.0°, 17.0° and 20.0°. CNF film displayed characteristic diffraction peaks at 2θ of 16.2° and 22.3°, which represent a typical Type-I crystalline structure (Lu, Lin, Tang, Wang, Chen & Huang, 2015), showing that the purification and melt processing of CNF had little effects on its crystalline structures. The crystallinity of the films increased with CNF content, indicating formation of discrete AM and CNF rich phases within the AM and CNF parts in the films as also demonstrated by CLSM (FIG. 2). Interestingly, the diffractograms did not seem to be entirely additive for AM and CNF and for the 50% and 100% CNF the cellulose crystalline polymorph dominated. Glycerol did not have any significant effect on crystallinity for any of the film formulations except for the 50% CNF, which had an unexpectedly high crystallinity (Table 1). A 2-fold higher crystallinity as compared to the films without glycerol was found indicating that glycerol has weaker interaction with CNF than with AM creating an imbalance in the composites when the amount of CNF exceed a certain limit. This can increase the relative amount of glycerol interacting with the starch-phase of the nanocomposite allowing more moisture absorption and the overall crystallinity. This was confirmed by the small change of crystallinity for pure CNF films and by the water contact angle of 50/% CNF films that does not follow the trend when 25% of glycerol was added.

### Example 8

### Nuclear Magnetic Resonance Magic-Angle Spinning

### Methods

Conventional solid-state NMR MAS experiments on ¹H were performed on a Bruker Avance III 600 MHz spectrometer, equipped with a triple resonance 1.3 mm fast-MAS (magic angle spinning) probe operating at ambient temperature. Zirconia rotors were used for all experiments, and spinning frequencies were set to 60.0 kHz and regulated to ±2 Hz. ¹H chemical shifts were referenced externally to the ¹H resonances of adamantane set at 1.8 ppm. Relaxation times were measured by using a standard saturation recovery sequence, consisting in a saturation block of multiple 90° pulses, followed by an increasing recovery time and a final 90° and acquisition. One dimensional 1H spectra were acquired with the use of a spin-echo sequence in order to remove the background signal from the probe. It consisted in a 90°—delay—180° sequence and the signal is detected after a second echo delay. Ultrafast magic angle spinning ¹H—¹H two-dimensional exchange spectra were recorded with increasing mixing times, and the changes in peak intensities were used to monitor the transfer of magnetization between the domains by spin diffusion. The sequence used was a standard NOESY sequence, suitable for identifying signals from protons in close proximity (Jennings et al., Polymer Chemistry, 2016, 7(4), 905; Ntountaniotis et al., Biochimica et Biophysica Acta (BBA)—Biomembranes, 2014, 1838(10), 2439).

### Results

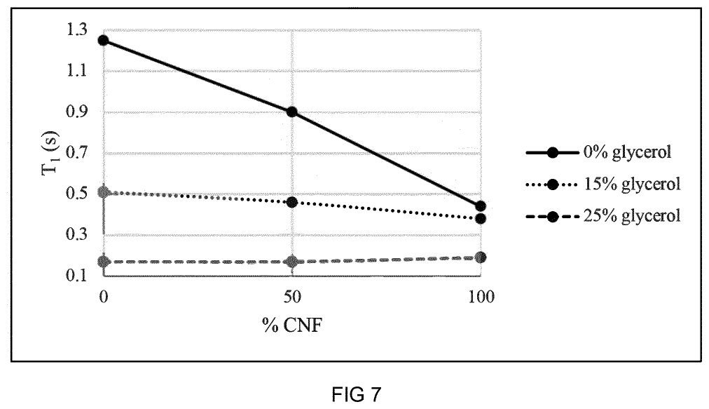

Solid-state NMR spectroscopy was used to evaluate the domain size of the different component on the whole sample. ¹H ultrafast-MAS solid-state NMR experiments were performed on AM/CNF pure and composite films. NMR relaxation measurements are sensitive to the crystalline nature of the materials, high degree of crystallinity induce a strong network of dipole-dipole interactions which results in fast spin-lattice relaxation times (T₁). Relaxation was monitored over a range of 100 s for each sample and the extracted relaxation times were fast (order of magnitude of a few seconds) and characterized by a mono-exponential behavior. This, together with the fact that all the chemical sites show the same relaxation behavior, suggests that the domains present in the composites were relatively small (nm scale) and intimately distributed. The relaxation times decreased with the increase of the glycerol content of the films. Moreover, the relaxation times decreased as CNF was increased in the films and this effect was most noticeable in absence of glycerol (FIG. 7). The addition of glycerol substantially modified the relaxation behaviour of all the films by decreasing the relaxation, compatible with a plasticizing effect of the glycerol.

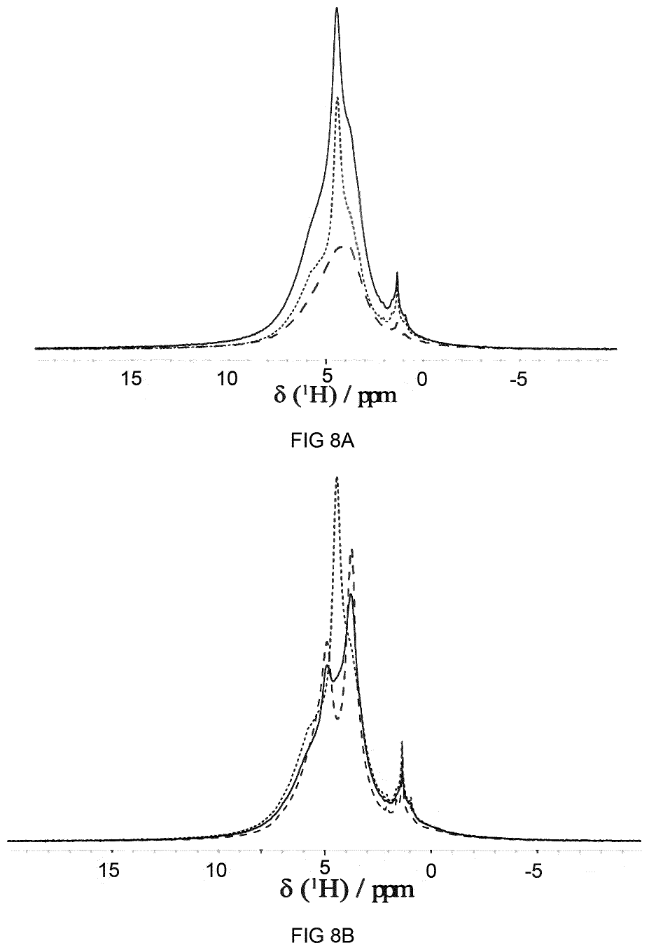

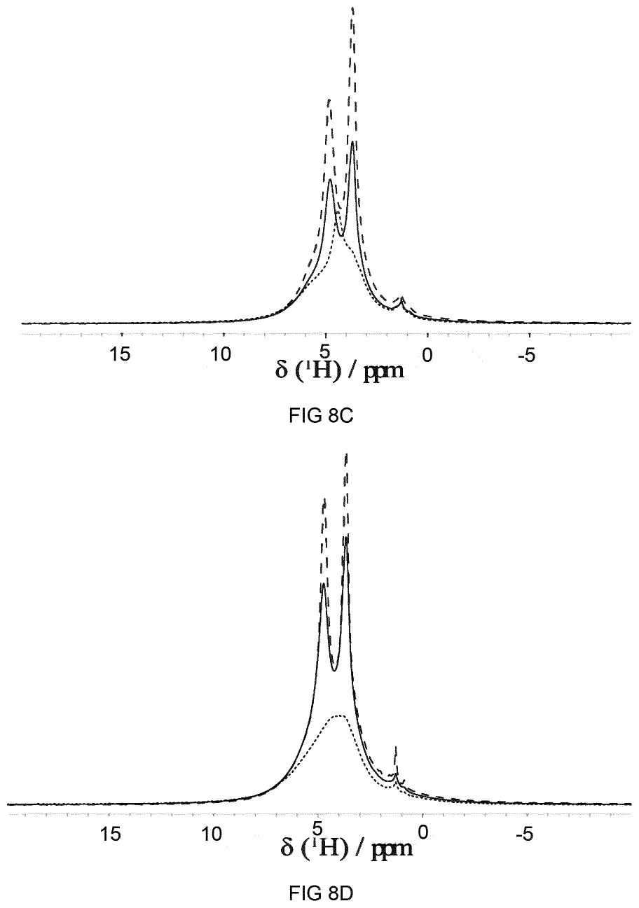

Ultrafast-MAS ¹H spin-echo experiments were performed at 60.0 kHz to characterize the chemical environments of the films. All the spectra show an aliphatic region between 0 and 2 ppm indicating small amount of impurities. Spectra for the films without glycerol were not resolved enough to differentiate between the different chemical sites. Even though the resolution did not fully resolve each chemical environment of the protons it was clear that AM showed a spectrum with a relative sharp peak centered at approx. 4 ppm, characterized by two small shoulders, one at 3.5 ppm and the second one at approximately 6.0 ppm (FIG. 8A). The CNF spectrum instead showed only one broad resonance at 4 ppm. However, the lack of resolution for the pure spectra makes the structural analysis and the peak assignment impossible.

On the other hand, the effect of the addition of glycerol (FIGS. 8 B,C,D) is easily noticeable by the appearance of two sharp and intense glycerol resonances, at 3.7 and 4.8 ppm respectively, which substantially overlapped with the AM/CNF unresolved protons.

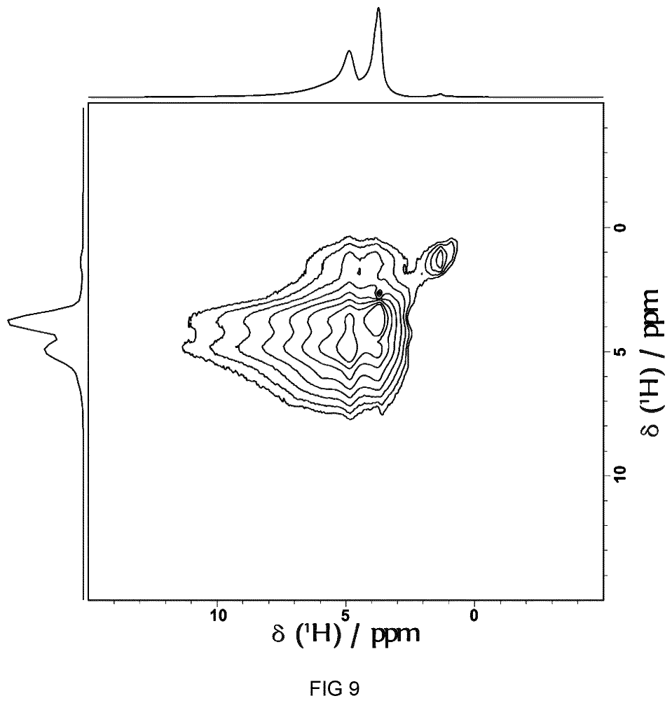

To obtain additional data on the average domain size, solid-state NMR ¹H—¹H spin diffusion measurements were carried out. The NOESY proton-exchange experiment (FIG. 9), performed at a different mixing times in the range 1 to 300 ms, showed the presence of cross-peaks demonstrating that there is a substantial fast magnetization exchange transferring the polarization between the different domains of the matrix. This suggests that the relative domain size in the samples are small, which is compatible with the previous observation that only a single mono-exponential relaxation behavior is present for all peaks. However, since the glycerol signals obscure the AM/CNF chemical shifts and due to the similarity of the two AM and CNF pure films, calculation of the copolymeric blocks are not precise. However, from the resolved glycerol peak signal it is possible to estimate the upper limit for the glycerol domain size according to (Pili et al., Chemistry of Materials, 2018, 30(21), 7593)<r²>=6 Dt, setting the spin diffusion coefficient to the order of magnitude of 10⁻¹⁶ m²s⁻¹ and t to T₁, an upper limit of 20 nm can be assumed for the domain size of the glycerol. These data are compatible with the CLSM results (FIG. 2) in which the phase separation involves only starch and cellulose.

### Example 9

### Mechanical Properties

### Methods

The films were cut into rectangular strips of length=100 mm and width=8 mm, Film thickness, as measured by a micrometer screw gauge, varied as a function of the composition. The tensile tests were performed using an Instron machine model 5569 (MTS, USA) equipped with a 5 kN tensile load cell. The distance between clamps was 60 mm and the crosshead speed were set at 10 mm min₋₁. The elongation and tensile stress at break were measured at 18° C. and 50% humidity. Each analysis was performed at least in triplicate (Follain, Joly, Dole & Bliard, Journal of Applied Polymer Science, 2005, 97(5), 1783).

### Results

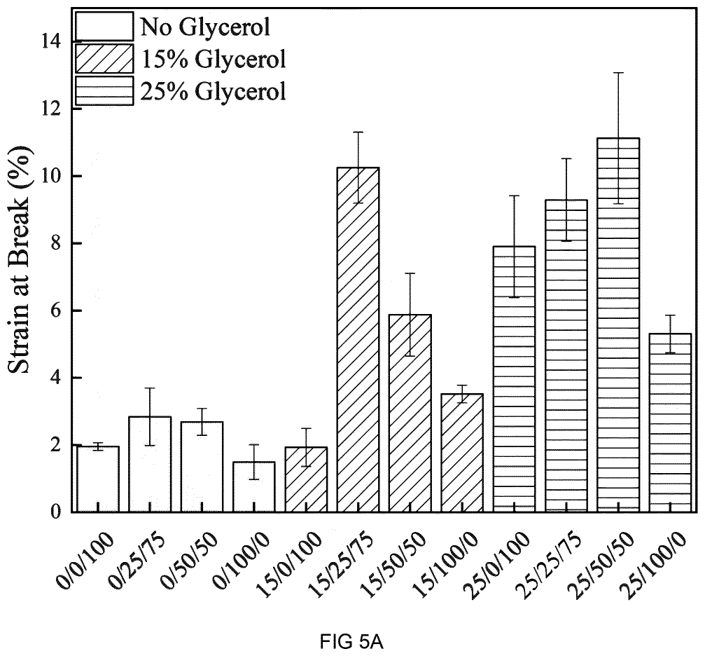

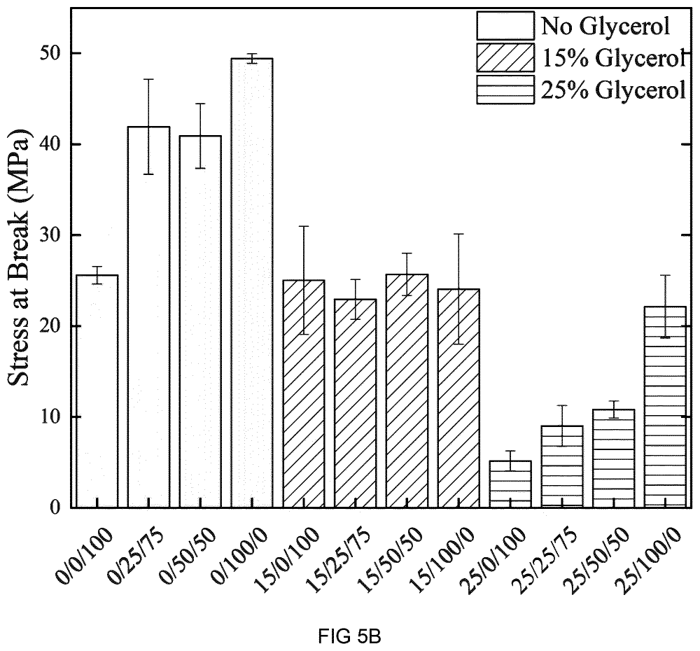

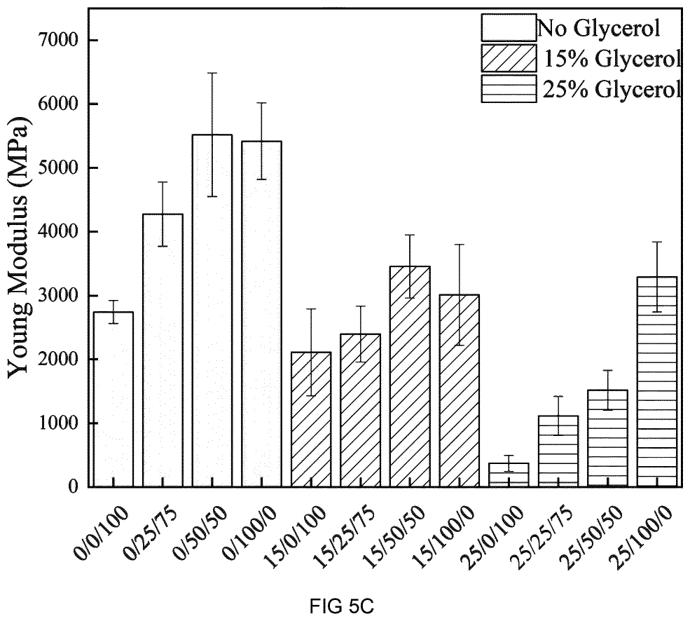

The deformation behavior of AM/CNF pure and composite films as characterized by tensile tests and calculation of the parameters strain at break, stress at break and Young's modulus showed that the films were influenced by all three components AM, CNF and glycerol (FIG. 5). The presence of glycerol decreased the stiffness and strength of the films and increased elasticity. In particular, when we intended to plasticize the AM films with 15% of glycerol an anti-plasticization effect was observed as demonstrated by decreased strain at break. Interestingly, the addition of 25% CNF reverted the anti-plasticization showing a 5-fold increase in the strain at break, which is a typical effect for nanocomposites. The strain at break decreased with increased CNF and for the pure CNF, strain at break increased only 2-fold confirming the lower affinity of CNF to glycerol. At higher concentration of glycerol, the strain at break increased significantly with the concentration of CNF in the composites.

Increased CNF:AM ratio resulted in higher stress at break for the films without glycerol, demonstrating that CNF had a significant strengthening effect on the composites. In the presence of glycerol there was a drop in the strength of all the films (FIG. 5, “stress at break”). At 15% glycerol, the stress at break of the samples was not significantly different for any of the films. However, the Young's modulus (stiffness) of these films increased with increasing CNF content. When glycerol content was increased to 25%, the strength of AM and composites films showed a notable decrease. However, the pure CNF films showed indifferent strength, virtually independent of the glycerol content demonstrating that CNF has a great potential as filler and reinforcer. As deduced from the combined high stress and strain at break, the CNF films showed high cohesiveness even with high concentration of glycerol.

### Example 10

### Dynamic Mechanical Analysis with Temperature and Humidity Control

### Methods

Dynamic mechanical analysis (DMA, Triton technology, 2101405) with a temperature gradient was performed in tension mode with a displacement of 0.005 mm and frequencies of 1 and 10 Hz. A standard heating rate of 3° C. min⁻¹ was used and a ramp from −50 to 120° C. The experiments were performed on prototypes with a length of 10 mm. The glass transition temperature was estimated by comparing the derivative function of the storage modulus and the tan delta (tanδ) peak (Sagnelli et al., Coatings 2019, 9(8), 482).

### Results

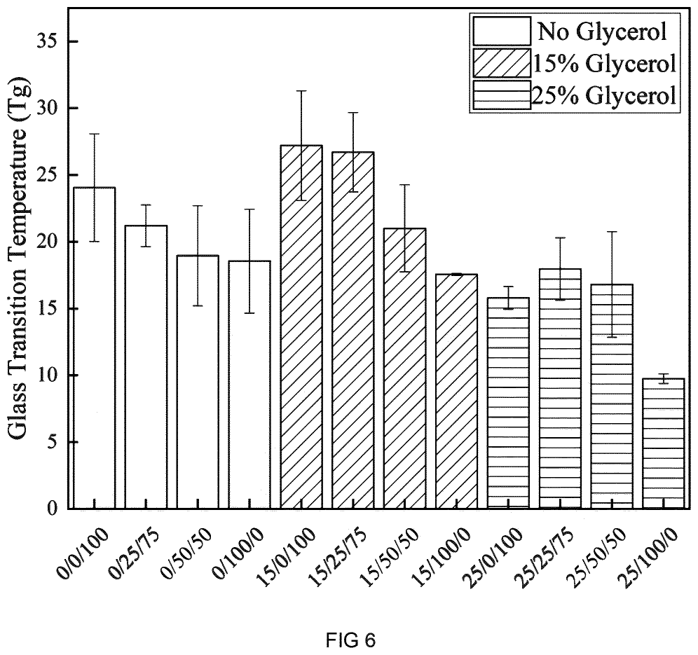

The visco-elastic properties of the films were analyzed with a dynamic mechanical analyzer (DMA) using tension mode and temperature gradients to estimate the glass transition temperature and calculating the tan δ peak (Sagnelli et al., Carbohydr Polym, 2017, 172, 237). There was a general trend that the presence of CNF and glycerol decreased the Tg of the films (FIG. 6). However, just as shown for the strain at break, a weak anti-plasticization effect was observed at 15% glycerol for the films with high AM content. Generally, at 25% glycerol Tg was decreased demonstrating a notable plasticized system where the polymers chains have flexibility in the plasticizer-rich phases.

### Example 11

### Permeability to Gases

### Methods

Gas permeability was monitored using thin films prepared by casting. A 2% (w/w) starch suspension was gelatinized using a microwave oven for 3 min in a Duran bottle closed using a membrane screw-cap to avoid over-pressure. After gelatinization, the samples were stirred for 5 min at 300 rpm and poured in the petri dishes coated with teflon, and preheated at 70° C. for 3 h using maximum oven ventilation and there after at 50° C. for 10 to 12 h without ventilation. The films were placed in a desiccator for two days at 85% RH in order to balance the moisture. The films were cut into 5 cm² before test. CO₂, O₂, and H₂O permeability were determined using the American Society for Testing and Materials (ASTM) Standard Method D 3985 (2010) and F1249 (MultiPerm apparatus-ExtraSolution s.r.I., Pisa, Italy). The experiment was performed at 25° C. under 85% RH. All tests were carried out in duplicates.

### Results

Water vapor (WVP), carbon dioxide (CO₂) and oxygen (O₂) permeability measurements were carried out on films without glycerol (Table 2). AM films (0/0/100) were too fragile to be tested for O₂ and CO₂. WVP decreased with increased CNF; the pure AM films showed a 7-fold higher WVP than the CNF films. Furthermore, the WVP of all the composite films were far lower than the majority of petroleum-based materials (Ferrer, Pal & Hubbe, Industrial Crops and Products, 2017, 95, 574). The same effects of CNF were seen for O₂ and CO₂, especially for the O₂ permeability showing a 3-fold decrease as compared to the AM-rich composites. The reduced O₂ permeability can be advantageous for packaging purposes.

TABLE 2
Barrier properties of AM/CNF pure and composite films.

| | | Permeability (cm³ · mm · kPa/m² 24 h) | | |
|---|---|---|---|---|
| Composition | Thickness | O₂ | CO₂ | H₂O |
| 0/0/100 | 66 ± 2 | ND* | ND* | 0.351 ± 0.020 |
| 0/25/75 | 47 ± 4 | 13.0 ± 3 | 0.14 ± 0.05 | 0.059 ± 0.007 |
| 0/50/50 | 68 ± 2 | 4.2 ± 2.6 | 11 ± 0.5 | 0.056 ± 0.001 |
| 0/100/0 | 43 ± 2 | 3.1 ± 0.1 | 1.83 ± 0.01 | 0.057 ± 0.009 |

*Not determined due to fragility.

### Example 12

### Comparison to High-Amylose Starch-Based Composite Materials

### Methods

The composite material as outlined in Examples 1-11 is compared to a composite material prepared from mixing a high-amylose starch with a cellulose nanofibre. Specifically, the following four compositions are prepared:
Composite A: 10 to 40% cellulose nanofibres; 55 to 75% amylose composition according to the present disclosure; 10 to 20% glycerol
Composite B: 10 to 40% cellulose nanocrystals; 55 to 75% amylose composition according to the present disclosure; 10 to 20% glycerol
Composite C: 10 to 40% cellulose nanofibres; 55 to 75% high-amylose starch (less than 95% amylose compared to the total amount of amylose and amylopectin in said amylose composition); 10 to 20% glycerol
Composite D: 10 to 40% cellulose nanocrystal; 55 to 75% high-amylose starch (less than 95% amylose compared to the total amount of amylose and amylopectin in said amylose composition); 10 to 20% glycerol

The gelatinisation temperature, Young's modulus, tensile strength, and strain at break are assessed for all four materials.

### Results

Composites A and B are expected to exhibit significantly improved properties with respect to gelatinisation temperature, Young's modulus, tensile strength, and/or strain at break compared to composites C and D. Composite A is expected to exhibit significantly improved properties with respect to gelatinisation temperature, Young's modulus, tensile strength, and/or strain at break compared to composite B.

### Example 13

### Comparison to High-Amylose Starch-Based Materials

### Methods

Two materials—“amylose only” from barley (AOS) and “high amylose” (50%) starch” from maize (HAS)—were prepared as described below. AOS was prepared from “amylose only” starch from barley, which has an amylose content of 99% compared to total amylose+amylopectin (also referred to as “AM” herein). AM was prepared from the barley plant described in Example 1 and extracted according to method 2 described in Example 1. HAS is a control prepared from “high amylose” starch from maize, which has an amylose content of 50% compared to total amylose+amylopectin.

2% of each starch solution with 30% of glycerol content was prepared. Each solution was heated while stirring at 140° C. for 30 min using high-pressure glass reactor, each solution cooled to approximately 70° C. then cast in Teflon petri dishes. Films were dried at 50° C. in a ventilated oven until complete dryness. Films placed in a sealed desiccator containing potassium chloride saturated solution (RH 85%, 20° C.) to equilibrate the moisture content before the analysis.

The barley amylose-only (AOS) exhibited a degree of branching (α-1,6/α-1,4 in %) of 1.0, as assessed by ¹H-NMR.

### Results

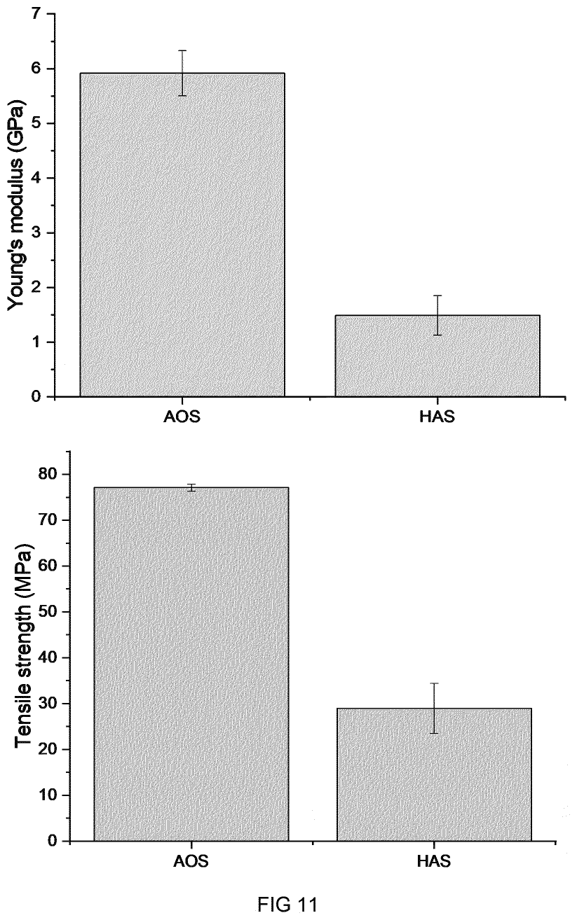

A comparison of the tensile strengths and the Young's moduli is shown in FIG. 11. The AOS film exhibited a significantly higher Young's modulus (5.9 GPa) compared to the HAS film (1.5 GPa). Similarly, the AOS film showed a substantially higher tensile strength (77.1 MPa) compared to the HAS film (28.9 MPa).

### Conclusion

These findings show that AOS film showed substantially improved mechanical properties (tensile strength and Young's modulus) as compared to the HAS film.

### Example 14

### Thermal properties of Amylose Materials

### Methods

Thermal properties of amylose only barley starch (AM)(prepared as described in Example 1, Method 2), granules, high amylose corn starch (G80) granules and normal corn starch (NMS) granules measured using DSC in triplicate. Whereas AM is extracted as such from barley, the amylose from potato was further purified from potato starch.

### Results

The DSC results are summarised in Table 3. The degree of branching (α-1,6/α-1,4 in 15%) as determined by ¹H-NMR was as follows: Barley amylose only (AM): 1.0. Maize purified amylose: 1.8. Potato purified amylose: 0.7.

Table 3: Differential Scanning calorimetry, DSC: Thermal properties of high amylose maize starch (HAS, G80, 49.9% amylose) and amylose only barley starch (AM, 99% amylose). Data are presented as mean±standard deviation of triplicate measurements. Tₒ: Onset temperature. T_{P}: Peak temperature. T_{C}: Conclusion temperature. ΔH: Enthalpy change.

| | DSC Peak | | | |
|---|---|---|---|---|
| Sample | T_{O} (° C.) | T_{P} (° C.) | T_{C} (° C.) | ΔH (J/g) |
| AM | 88.2 ± 0.4 | 95.2 ± 0.1 | 102.2 ± 0.0 | 5.4 ± 0.7 |
| HAS (G80) | 64.6 ± 1.5 | 82.8 ± 0.9 | 111.2 ± 0.6 | 10.2 ± 0.5 |
| NCS | 66.2 ± 0.1 | 70.2 ± 0.1 | 76.8 ± 0.7 | 13.0 ± 0.9 |

### Conclusion

DSC data provide documentation that the AOS has lower enthalpy, ΔH, of gelatinisation, higher gelatinisation point and a narrower range of gelatinization than the maize G80 HAS.

### Example 15

### Mechanical Properties of Amylose (AM) and High Amylose Composite (HA) Films with Cellulose Nanofibers (CNF)

### Preparation and Casting of Composite Films

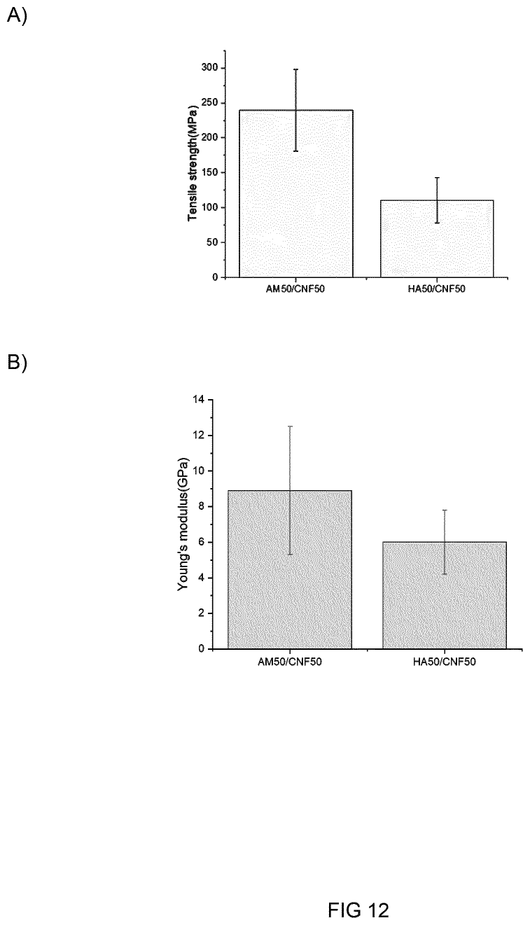

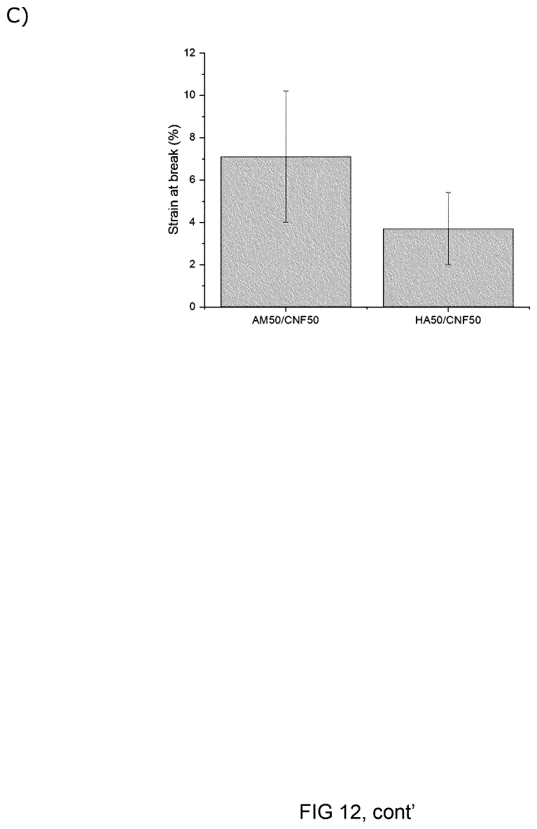

Two composites were prepared using CNF prepared as described in Example 1. One composite was made using Amylose Only (AM, 99% amylose) prepared as described in Example 1 (Method 2) at an AM:CNF ratio of 50:50 (w/w %). The other control composite was made with High Amylose (HA, 50% amylose content) prepared from maize at a ratio of HA:CNF of 50:50 (w/w%). Each constituents (1% each of AM, HA and CNF and glycerol concentration 25%) were heated while stirring for 30min at 140° C. using high-pressure glass reactor. Then the solutions were cooled to 70° C., degassed and immediately cast in Teflon coated petri dishes. Films were dried at 50° C. until complete dryness. The mechanical properties were measured as described above. The results are shown in FIG. 12.

### Conclusion:

The AM:CNF composite film had 2-fold higher tensile than the HA:CNF composite film. The strain at break showed a tendency for being higher for the AM:CNF. The Young's modulus was similar for both films.

1. A composite material prepared at least from:
a. an amylose composition,
b. cellulose nanofibres (CNF) or cellulose nanocrystals (CNC), and
c. a plasticiser,
wherein less than 1.4% of the glucosidic bonds within the amylose composition are α(1→6) glucosidic bonds, and wherein the composite material comprises in the range of 5 to 60% cellulose nanofibres or cellulose nanocrystals.

2. A composite material prepared at least from:
a. an amylose composition,
b. cellulose nanofibres (CNF) or cellulose nanocrystals (CNC), and
c. a plasticiser,
wherein said amylose composition comprises at least 96% amylose compared to the total amount of amylose and amylopectin in said amylose composition, and wherein the composite material comprises in the range of 5 to 60% cellulose nanofibres or cellulose nanocrystals.

3. The composite material according to claim 1, wherein the amylose composition comprises at least 96% amylose compared to the total amount of amylose and amylopectin in said amylose composition.

4. The composite material according to any one of the preceding claims, wherein the ratio by weight of amylose composition to cellulose nanofibre or cellulose nanocrystals is in the range of 20:1 to 1:10, such as in the range of 20:1 to 1:5, such as in the range of 20:1 to 1:3, such as in the range of 20:1 to 1:2.

5. The composite material according to any one of the preceding claims, wherein the amylose composition comprises at least 97% amylose compared to the total amount of amylose and amylopectin in said amylose composition, such as at least 98% amylose, such as at least 99% amylose.

6. The composite material according to any one of the preceding claims, wherein said amylose composition comprises less than 4% amylopectin, such as less than 3% amylopectin, such as less than 2% amylopectin, such as less than 1% amylopectin, such as no amylopectin.

7. The composite material according to any one of the preceding claims, wherein the composite material comprises less than 4% amylopectin, such as less than 3% amylopectin, such as less than 2% amylopectin, such as less than 1% amylopectin, such as no amylopectin.

8. The composite material according to any one of the preceding claims, wherein less than 1.4%, such as less than 1.2%, such as less than 1.0%, such as less than 0.8% , such as less than 0.6%, such as 0.5% of the glucosidic bonds within the amylose composition are α(1→6) glucosidic bonds, wherein the glucosidic bonds are either α(1→4) or α(1→6) glucosidic bonds.

9. The composite material according to any one of the preceding claims, wherein the glucosidic bonds in said amylose composition has a ratio of α(1→4) glucosidic bonds to α(1→6) glucosidic bonds of at least 80, such as at least 100, such as at least 120, such as at least 140, such as at least 160, such as at least 180, such as at least 200, such as at least 220, such as at least 240.

10. The composite material according to any one of the preceding claims, wherein the amylose composition is obtained from a plant.

11. The composite material according to any one of the preceding claims, wherein the amylose composition is obtained from a plant, wherein the starch of said plant comprises at least 96% amylose compared to the total amount of amylose and amylopectin in said starch, such as at least 97% amylose, such as at least 98% amylose, such as at least 99% amylose.

12. The composite material according to any one of the preceding claims, wherein said composite material does not comprise any starch apart from said amylose composition.

13. The composite material according to any one of the preceding claims, wherein the plant is a transgenic plant.

14. The composite material according to any one of claims 10 to 13, wherein the plant has reduced expression and/or activity of at least one starch branching enzyme.

15. The composite material according to any one of claims 10 to 14, wherein the plant has been modified to reduce expression of at least one starch branching enzyme.

16. The composite material according to any one of claims 14 to 15, wherein the starch branching enzymes are selected from the group consisting of SBEI of SEQ ID NO: 1, SBEIIa of SEQ ID NO: 2, SBEIIb of SEQ ID NO: 3 and functional homologues thereof sharing at 70%, such as at least 80%, for example at least 90%, such as at least 95% sequence identity with any of the aforementioned.

17. The composite material according to any one of claims 10 to 14, wherein the plant has been modified to reduce expression of one or more of the following, for example of all of the following:
a. SBEI of SEQ ID NO: 1 or a functional homologue thereof sharing at 70%, such as at least 80%, for example at least 90%, such as at least 95% sequence identity therewith; and
b. SBEIIa of SEQ ID NO: 2 or a functional homologue thereof sharing at 70%, such as at least 80%, for example at least 90%, such as at least 95% sequence identity therewith; and
c. SBEIIb of SEQ ID NO: 3 or a functional homologue thereof sharing at 70%, such as at least 80%, for example at least 90%, such as at least 95% sequence identity therewith.

18. The composite material according to any one of claims 15 to 17, wherein said modifying said plant to reduce expression of one or more genes encoding starch branching enzyme is obtained by RNA interference, antisense expression, chemical mutagenesis, mutagenesis by radiation, mutagenesis by natural selection, and/or genome editing.

19. The composite material according to any one of claims 10 to 18, wherein the plant is selected from the group consisting of barley, maize, wheat, potato, rice, cassava, sweet potato, oats, lesser jam, turmeric root, buckwheat, quinoa, rye, black eye bean, chickpea, dry foul bean, ginger, mung bean, pinto, sago, water chestnut, and white kidney bean, or a hybrid of said plants.

20. The composite material according to any one of the preceding claims, wherein the plant is barley.

21. The composite material according to any one of the preceding claims, wherein the composite material comprises in the range of 6 to 94% amylose composition.

22. The composite material according to any one of the preceding claims, wherein the composite material comprises in the range of 5 to 55% cellulose nanofibres or 5 to 55% cellulose nanocrystals.

23. The composite material according to any one of the preceding claims, wherein the composite material comprises in the range of 20 to 55% cellulose nanofibres or 20 to 55% cellulose nanocrystals.

24. The composite material according to any one of the preceding claims, wherein the composite material comprises in the range of 15 to 35% cellulose nanofibres or 15 to 35% cellulose nanocrystals.

25. The composite material according to any one of the preceding claims, wherein the composite material comprises in the range of 40 to 60% cellulose nanofibres or 40 to 60% cellulose nanocrystals.

26. The composite material according to any one of the preceding claims, wherein the cellulose nanofibres are obtained from agrowaste.

27. The composite material according to any one of the preceding claims, wherein the agrowaste is a vegetable pulp.

28. The composite material according to any one of the preceding claims, wherein the vegetable pulp is obtained from sugar beet, potato tuber, and/or carrot.

29. The composite material according to any one of the preceding claims, wherein the vegetable pulp is sugar beet pulp.

30. The composite material according to any one of the preceding claims, wherein at least 90% of the cellulose nanofibres have aspect ratios falling within the range of 1.6 to 400.

31. The composite material according to any one of the preceding claims, wherein at least 90% of the cellulose nanofibres have lengths falling within the range of 400 to 4500 nm, such as 600 to 4500 nm, such as 600 to 2000 nm.

32. The composite material according to any one of the preceding claims, wherein the composite material comprises in the range of 1 to 30% plasticiser, such as in the range of 5 to 30% plasticiser, such as in the range of 10 to 30% plasticiser, such as in the range of 15 to 25% plasticiser.

33. The composite material according to any one of the preceding claims, wherein the composite material comprises in the range of 1 to 10% plasticiser.

34. The composite material according to any one of the preceding claims, wherein the composite material comprises in the range of 10 to 20% plasticiser.

35. The composite material according to any one of the preceding claims, wherein the composite material comprises in the range of 20 to 30% plasticiser.

36. The composite material according to any one of the preceding claims, wherein the plasticiser comprises or consists of one or more compounds selected from the group consisting of glycols, polyethers, carboxylic esters, saccharides such as monosaccharides, disaccharides, oligosaccharides, polysaccharides, alkyl citrates, acetylated monoglycerides, epoxidised oils, adipic acid esters, benzoic acid esters, phosphoric acid esters, polyesters, sebacic acid esters, and urea.

37. The composite material according to any one of the preceding claims, wherein the plasticiser comprises or consists of one or more compounds selected from the group consisting of glycols, polyethers, carboxylic esters, saccharides such as monosaccharides, disaccharides, oligosaccharides, or polysaccharides, alkyl citrates, acetylated monoglycerides, and epoxidised oils.

38. The composite material according to any one of the preceding claims, wherein the plasticiser comprises or consists of one or more compounds selected from the group consisting of glycerol, sorbitol, ethylene glycol, formamide, and urea.

39. The composite material according to any one of the preceding claims, wherein the plasticiser comprises or consists of glycerol.

40. The composite material according to any one of the preceding claims, wherein the composite material has a water contact angle of 40 to 120°.

41. The composite material according to any one of the preceding claims, wherein the composite material has a Young's modulus of at least 1000 MPa.

42. The composite material according to any one of the preceding claims, wherein the composite material has a Young's modulus of in the range of 1000 to 10000 MPa, such as 1500 to 9000 MPa, such as 2000 to 8000 MPa.

43. The composite material according to any one of the preceding claims, wherein the composite material exhibits a strain at break of in the range of 1 to 18%.

44. The composite material according to any one of the preceding claims, wherein the composite material exhibits a stress at break of in the range of 5 to 60 MPa.

45. The composite material according to any one of the preceding claims, wherein the composite material has a permeability to O₂ of less than 100 cm³·mm/(m²·kPa·24 h), such as less than 60 cm³·mm/(m²·kPa·24 h), such as less than 40 cm³·mm/(m²·kPa·24 h), such as less than 30 cm³·mm/(m²·kPa·24 h), such as less than 20 cm³·mm/(m²·kPa·24 h).

46. The composite material according to any one of the preceding claims, wherein the composite material has a permeability to CO₂ of less than 100 cm³·mm/(m²·kPa·24 h), such as less than 60 cm³·mm/(m²·kPa·24 h), such as less than 40 cm³·mm/(m²·kPa·24 h), such as less than 30 cm³mm/(m²·kPa·24 h), such as less than 20 cm³mm/(m²·kPa·24 h).

47. The composite material according to any one of the preceding claims, wherein the composite material has a permeability to water of less than 30 cm³·mm/(m²·kPa·24 h), such as less than 10 cm³·mm/(m²kPa·24 h), such as less than 5 cm³·mm/(m²·kPa·24 h), such as less than 1 cm³·mm/(m²·kPa·24 h), such as less than 0.3 cm³·mm/(m²·kPa·24 h).

48. The composite material according to any one of the preceding claims, wherein the material is biodegradable.

49. A method of preparing a composite material, said method comprising:
a. providing an amylose composition, wherein less than 1.4% of the glucosidic bonds within the amylose composition are α(1→6) glucosidic bonds, wherein the glucosidic bonds are either α(1→4) or α(1→6) glucosidic bonds;
b. providing cellulose nanofibres or cellulose nanocrystals;
c. providing a plasticiser;
d. mixing said amylose composition, said cellulose nanofibre or cellulose nanocrystals, and said plasticiser in a ratio so that the cellulose nanofibres or the cellulose nanocrystals constitute in the range of 5 to 60% of the weight of the composite material, and
e. heating said mixture to obtain said composite material.

50. A method of preparing a composite material, said method comprising:
a. providing an amylose composition, wherein said amylose composition comprises at least 96% amylose compared to the total amount of amylose and amylopectin in said amylose composition;
b. providing cellulose nanofibres or cellulose nanocrystals;
c. providing a plasticiser;
d. mixing said amylose composition, said cellulose nanofibre or cellulose nanocrystals, and said plasticiser in a ratio so that the cellulose nanofibres or the cellulose nanocrystals constitute in the range of 5 to 60% of the weight of the composite material, and
e. heating said mixture to obtain said composite material.

51. The method according to any one of claims 49 to 50, wherein said amylose composition, said cellulose nanofibres or cellulose nanocrystals, and said plasticiser is mixed in a ratio so the composite material comprises in the range of 6 to 94% of said amylose composition.

52. The method according to any one of claims 49 to 50, wherein said amylose composition, said cellulose nanofibre or cellulose nanocrystals, and said plasticiser is mixed in a ratio so the composite material comprises in the range of 1 to 30% of said plasticiser.

53. The method according to any one of claims 49 to 52, wherein the ratio by weight of amylose composition to the cellulose nanofibres or the cellulose nanocrystals is in the range of 20:1 to 1:10.

54. The method according to any one of claims 49 to 53, wherein the amylose composition is as defined in any one of claims 3 to 20.

55. The method according to any one of claims 49 to 54, wherein the cellulose nanofibre is as defined in any one of claims 22 to 31.

56. The method according to any one of claims 49 to 55, wherein the plasticiser is as defined in any one of claims 32 to 39.

57. A packaging comprising the composite material according to any one of claims 1 to 48.


SEQUENCE LISTING (3 sequences)

SEQ ID NO: 1 - protein, 775 aa, Hordeum vulgare
  MISC_FEATURE (1)..(775): Starch Branching Enzyme I
SKLSLPVSAPRDFTMATAQDGADDLPIYDLDPKFAGFKDHFSYRMKKYRDQKHLIDEHEGGLEEFSKGYLKFGINTENDATVYREWAPAAKEAQVIGDFNNWNGSGHRMTKDNFGVWSIRISHVNGKPAIPHNSKVKFRFHRGDGVWVDRIPAWIRYAIADASKFGAPYDGVHWDPPTSERYVFKHPRPQKPDAPRIYEAHVGMSGEKPEVSTYREFADNVLPRVKANNYNTVQLMAIKEHSYYASFGYHVTNFFAASSRSGTPEDLKYLVDKAHSLGLRVLMDVVHSHASSNMTDGLNGYDVGQNTQESYFHTGERGYHKLWDSRLFNYANWEVLRFLLSNLRYWMDEFMFDGFRFDGVTSMLYNHHGINMSFSGDYKEYFGLDTDVDAVVYMMLANHLMHKLLPEATIVAEDVSGMPVLCRSVDEGGVGFDYRLAMAIPDRWIGYLKNKDDLEWSMSGIAHTLTNRRYTEKCIAYAESHDQSIVGDKTMAFLLMDKEMYTGMSDLQPASPTIDRGIALQKMIHFITMALGGDGYLNFMGNEFGHPEWIDFPREGNNWSYDKCRRQWSLVDIDHLRYKYMNAFDQAMNALDDKFSFLSSSKQIVSDMNEEKKVIVFERGDLVFVFNFHPNKTYDGYKVGCDLPGKYKVALDSDALMFGGHGRVAHDSDHFTSPEGIPGVPETNFNNRPNSFKILSPPRTCVAYYRVEEKAEKPKDGGAAFWGKLLRDTSMLKLLASKDATDGEAISGSEKVSTGDGSVKRGINFVFRSPDKDNK

SEQ ID NO: 2 - protein, 734 aa, Hordeum vulgare
  MISC_FEATURE (1)..(734): Starch Branching Enzyme IIa
MAEVNMTGGAAEKLESSEPTQGIAETITDGVTKGVKELVVGEKPQVVPKPGDGQKIYEIDPTLKDFRSHLDYRYSEYKRIRAAIDQHEGGLEVFSRGYEKLGFTRSAKGITYREWAPGAHSAALVGDFNNWNPNADTMTRDDYGVWEIFLPNNADGSPAIPHGSRVKIRMDTPSGVKDSISAWIKFSVQAPGEIPFNGIYYDPPEEEKYVFQHPQPKRPESLRIYESHIGMSSPEPKINSYANFRDEVLPRIKRLGYNAVQIMAIQEHSYYASFGYHVTNFFAPSSRFGTPEDLKSLIDRAHELGLLVLMDIVHSHSSNNTLDGLNGFDGTDTHYFHGGPRGHHWMWDSRLFNYGSWEVLRFLLSNARWWLEEYKFDGFRFDGVTSMMYTHHGLQMTFTGNYGEYFGFATDVDAVVYLMLVNDLIHGLYPDAVSIGEDVSGMPTFCIPVPDGGVGFDYRLHMAVADKWIELLKQSDESWKMGDIVHTLTNRRWLEKCVTYAESHDQALVGDKTIAFWLMDKDMYDFMALDRPSTPRIDRGIALHKMIRLVTMGLGGEGYLNFMGNEFGHPEWIDFPRGPQTLPTGKVLPGNNNSYDKCRRRFDLGDADFLRYRGMQEFDQAMQHLEEKYGFMTSEHQYVSRKHEEDKVIIFERGDLVFVFNFHWSNSKKDYRVGCSKPGKYKVALDSDDALFGGFSRLDHDVDYFTTEHPHDNRPRSFSVYTPSRTAVVYALTE

SEQ ID NO: 3 - protein, 829 aa, Hordeum vulgare
  MISC_FEATURE (1)..(829): Starch Branching Enzyme IIb
MAAPAFAVSAAGIARPSARRSSGAEPRSLLFGRNKGTRFPRAVGVGGSGWRVVMRAGGPSGEVMIPDGGSGGSGTPPSIEGSVQFESDDLEVPFIDDEPSLHDGGEDTIRSSETYQVTEEIDAEGVSRMDKESSTVKKIRIVPQPGNGQQIYDIDPMLRDFKYHLEYRYSLYRRIRSDIDEYDGGMDVFSRGYEKFGFVRSAEGITYREWAPGADSAALVGDFNNWDPTADHMSKNDLGIWEIFLPNNADGSPPIPHGSRVKVRMDTPSGTKDSIPAWIKYSVQTPGDIPYNGIYYDPPEEEKYVFKHPQPKRPKSLRIYETHVGMSSPEPKINTYANFRDEVLPRIKRLGYNAVQIMAIQEHSYYGSFGYHVTNFFAPSSRFGSPEDLKSLIDRAHELGLLVLMDVVHSHASSNTLDGLNGFDGTDTHYFHGGSRGHHWMWDSRVFNYGNKEVIRFLLSNARWWLEEYKFDGFRFDGATSMMYTHHGLQVTFTGSYHEYFGFATDVDAVVYLMLVNDLIHALYPEAVTIGEDVSGMPTFALPVQVGGVGFDYRLHMAVADKWIELLKGSDEGWEMGNIVHTLTNRRWLEKCVTYAESHDQALVGDKTIAFWLMDKDMYDFMALNGPSTPNIDRGIALHKMIRLITMALGGEGYLNFMGNEFGHPEWIDFPRGPQVLPTGKFIPGNNNSYDKCRRRFDLGDAEFLRYHGMQQFDQAMQHLEEKYGFMTSDHQYVSRKHEEDKVIVFEKGDLVFVFNFHWSNSYFDYRVGCLKPGKYKVVLDSDAGLFGGFGRIHHTGEHFTNGCQHDNRPHSFSVYTPSRTCVVYAPMN